(19) United States
(12) Patent Application Publication
(10) Pub. No.: US 2006/0061777 A1
(43) Pub. Date: Mar. 23, 2006

(54) Modifying digital documents

(75) Inventors: Mathew Christian Duggan, Cabarita (AU); Reuben Kan, Kellyville (AU)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/224,007

(22) Filed: Sep. 13, 2005

(30) Foreign Application Priority Data
Sep. 13, 2004 (AU) 2004905259
Sep. 13, 2004 (AU) 2004905260
Sep. 13, 2004 (AU) 2004905261

(51) Int. Cl. G06F 3/12

(52) U.S. Cl. 358/1.1

(57) ABSTRACT

A method (200) of modifying a digital document (300). The method (200) converts the digital document (300) into one or more first color digital images and generates a hard copy of the digital document (300). The method (200) generates one or more second color digital images of a modified version of the hard copy of the digital document (300). The method (200) compares the first one or more color digital images with the second one or more color digital images to determine the modifications made to the hard copy of the digital document (300) and modifies the digital document (300) based on the determined modifications.

### CROSS-REFERENCE TO RELATED PATENT APPLICATIONS

This application claims the right of priority under 35 U.S.C. § 119 based on Australian Patent Application No. 2004905259, filed 13 Sep. 2004, Patent Application No. 2004905260, filed 13 Sep. 2004, and Australian Patent Application No. 2004905261, filed 13 Sep. 2004, which are incorporated by reference herein in their entirety as if fully set forth herein.

### FIELD OF THE INVENTION

The present invention relates generally to word processing and, in particular, to a method and apparatus for modifying a digital document. The present invention also relates to a computer program product including a computer readable medium having recorded thereon a computer program for modifying a digital document.

### BACKGROUND

Despite predictions of a “paperless office”, with the advent of modern document editing software, most people still prefer reading and revising a printed paper copy (i.e., ‘hard copy’) of a digital document. This preference is mostly attributed to ease of navigation, ease of modification (e.g., amending and/or annotating), and higher information density provided by a hard copy of the digital document.

When drafting a large digital document, the author(s) of the digital document may print and revise the document several times. Each revision may involve reading through a hard copy of the document, and modifying the hard copy of the document using a highlighter, pen or pencil, for example. Once such a modification process is complete, someone is typically assigned the responsibility of integrating the modifications marked on the hard copy into a digital copy of the document. This conventional drafting process has the advantage that revision of the hard copy of the document may be performed by any interested party or group. Such a conventional drafting process also allows for any form of modification convenient for the contents of the document. Further, revision of the hard copy of the document may occur in any geographical location convenient for the revisor.

However, modifying a digital document, as described above, can be problematic. For example, the modification is slowed by the physical separation between the modified (e.g., amended and/or annotated) hard copy of the document(s) and the digital copy of the document displayed on a computer display screen, for example. Moving frequently between the two copies of the document often results in the author modifying the document losing context in one of the two copies of the document, and needing to search for a correct location again. This problem is further exacerbated when large modifications are made to the document and the location of text in the digital copy of the document moves by several pages. Further, integrating modifications into a digital copy of a document is prone to annotations or amendments being either missed (i.e., if not noticed on the hard copy), or postponed and forgotten.

Several methods are known which address the problems of modifying a digital document. One method uses a digital tablet device or some other similar device to capture movement of a user's pen as the user modifies the hard copy of the document. In response to the pen movements, modifications corresponding to the pen movements are input directly into the digital document. Another known method involves the use of a tablet style personal computer to provide portability and capture pen movements while also directly modifying the digital document.

Other known methods of modifying a document involve the use of a special “digital pen” device and specially marked paper to record movements of the digital pen. The modifications made to the document may later be imported into and aligned with a digital copy of the document.

Most of the above methods have the disadvantage of requiring specialised equipment that is not readily available to an average user. Some of the above methods do not provide the flexibility of geographical movement that a conventional pen and hard copy method of modifying provides. The methods involving specialised paper typically also require a user to perform a “calibration” step at the start of each page where the page of the document is identified, and the location of the paper with respect to a digitising device is established.

There are some further known methods of modifying a document that do not require special equipment. In accordance with these methods, modifications (e.g, annotations or amendments) to a hard copy of the document can be made with any brightly coloured pen. When the modifications are complete an image of the hard copy of the document is generated using a scanner. By analysing the generated image, modifications to the document may be identified by colour. Identifying modifications by colour has the disadvantage that such identification does not work for some coloured pens, or different types of marking (eg, highlighters, pencils). Such identification may be incorrectly performed on a document with coloured illustrations and tables where the illustrations themselves may be identified as modifications.

One known method of converting a modified hard copy of a document to a digital form uses Optical Character Recognition (“OCR”) to extract text portions from a document in order to reconstruct the document. Text portions not recognised by the OCR can be considered as modifications, which will need to be inspected by the user. However, existing OCR methods of modifying documents convert modifications to a digital form without reference to an original digital document. Such existing methods are advantageous when the original document is not available. However, existing OCR methods are prone to losing extra information (or metadata) associated with a digital document, such as revision histories, authorship information, complex text formatting rules and links to embedded objects (e.g., charts). Image quality in illustrations and diagrams may also be lost in OCR methods, through printing and scanning. The quality of such illustrations and diagrams may continue to degrade with each printing and scanning repetition.

Another known method of converting a modified hard copy of a document to a digital form, processes an image of the hard copy of the document in order to identify proofing marks used by professional proof readers, or some other predetermined symbols. While such a method is useful to a small percentage of persons who are familiar with the predetermined symbols, many people are not familiar with the symbols. These symbols are also inflexible in their meaning, so a person modifying a document will often wish to insert additional modifications, some of which may not be recognised.

Thus, a need clearly exists for an improved method of modifying a digital document.

### SUMMARY

It is an object of the present invention to substantially overcome, or at least ameliorate, one or more disadvantages of existing arrangements.

According to one aspect of the present invention there is provided a method of modifying a digital document, said method comprising the steps of:
converting said digital document into one or more first digital images;
generating one or more second digital images of a modified version of a hard copy of said digital document;
comparing the first one or more digital images with the second one or more color digital images to determine the modifications made to the hard copy of the digital document; and
modifying the digital document based on the determined modifications.

According to another aspect of the present invention there is provided an apparatus for modifying a digital document, said apparatus comprising:
conversion means for converting said digital document into one or more first digital images;
digital image generating means for generating one or more second digital images of a modified version of a hard copy of said digital document;
comparison means for comparing the first one or more digital images with the second one or more digital images to determine the modifications made to the hard copy of the digital document; and
digital document modifying means for modifying the digital document based on the determined modifications.

According to still another aspect of the present invention there is provided a computer program for modifying a digital document, said program comprising:
code for converting said digital document into one or more first digital images;
code for generating one or more second digital images of a modified version of the hard copy of said digital document;
code for comparing the first one or more color digital images with the second one or more color digital images to determine the modifications made to a hard copy of the digital document; and
code for modifying the digital document based on the determined modifications.

According to still another aspect of the present invention there is provided a computer program product having a computer readable medium having a computer program recorded therein for modifying a digital document, said computer program product comprising:
computer program code means for converting said digital document into one or more first digital images;
computer program code means for generating one or more second digital images of a modified version of a hard copy of said digital document;
computer program code means for comparing the first one or more digital images with the second one or more digital images to determine the modifications made to the hard copy of the digital document; and
computer program code means for modifying the digital document based on the determined modifications.

According to still another aspect of the present invention there is provided a method of determining the difference between at least a first and second digital image, said method comprising the steps of:
aligning the first digital image with the second digital image to determine one or more registered digital images;
aligning the colors of the first digital image with the colors of the one or more registered digital images to determine one or more color aligned digital images; and comparing the color aligned registered digital images with the first digital image to determine one or more differences between the first and second digital images.

According to still another aspect of the present invention there is provided an apparatus for determining the difference between at least a first and second digital image, said apparatus comprising:
digital alignment means for aligning the first digital image with the second digital image to determine one or more registered digital images;
color alignment means for aligning the colors of the first digital image with the colors of the one or more registered digital images to determine one or more color aligned digital images; and
comparison means for comparing the color aligned registered digital images with the first digital image to determine one or more differences between the first and second digital images.

According to still another aspect of the present invention there is provided a computer program for determining the difference between at least a first and second digital image, said program comprising:
code for aligning the first digital image with the second digital image to determine one or more registered digital images;
code for aligning the colors of the first digital image with the colors of the one or more registered digital images to determine one or more color aligned digital images; and
code for comparing the color aligned registered digital images with the first digital image to determine one or more differences between the first and second digital images.

Other aspects of the invention are also disclosed.

### BRIEF DESCRIPTION OF THE DRAWINGS

Some aspects of the prior art and one or more embodiments of the present invention will now be described with reference to the drawings and appendices, in which:

FIG. 1 is a schematic block diagram of a general-purpose computer upon which arrangements described can be practiced;

FIG. 2 is a flow diagram showing a method of detecting modifications to a document;

FIG. 3 is a data flow diagram showing an example of a digital document being processed in accordance with the method of FIG. 2;

FIG. 4 is a flow diagram showing a method of determining a coarsely registered image I″₂(x,y), as executed in the method of FIG. 2;

FIG. 5 is a flow diagram showing a method of determining rotation and scale parameters which relate two images, as executed in the method of FIG. 4;

FIG. 6 is a flow diagram showing a method of determining a translation relating two images, as executed in the method of FIG. 4;

FIG. 7 is a flow diagram showing a method of generating a complex image from an image, as executed in the method of FIG. 5;

FIG. 8 is a flow diagram showing a method of generating a representation of each of two complex images, as executed in the method of FIG. 5;

FIG. 9 is a flow diagram showing a method of performing Fourier-Mellin correlation, as executed in the method of FIG. 5;

FIG. 10 is a flow diagram showing a method of performing fine registration on a coarsely registered scanned page images, as executed during the method of FIG. 2;

FIG. 11 is a flow diagram showing a method of performing corner detection on a rendered page image, as executed during the method of FIG. 10;

FIG. 12 is a flow diagram showing a method of determining a displacement map, as executed during the method of FIG. 10;

FIG. 13 is a flow diagram showing a method of generating a distortion image, as executed during the method of FIG. 10;

FIG. 14(a) shows a dart in a triangulation G-Map;

FIG. 14 (b) shows three functions for operating on the dart of FIG. 14(a);

FIG. 14 (c) shows three darts produced by splitting a triangle into three sub-triangles;

FIG. 15 is a flow diagram showing a method of aligning colours of finely registered page images with rendered page images, as executed during the method of FIG. 2;

FIG. 16 is a flow diagram showing a method of generating a list of modifications, as executed during the method of FIG. 2;

FIG. 17 is a flow diagram showing a method of generating hotspot images, as executed during the method of FIG. 2;

FIG. 18 is a flow diagram showing a method of detecting hot modifications, as executed during the method of FIG. 2;

FIG. 19 is a flow diagram showing a method of merging modifications as executed during the method of FIG. 2;

FIG. 20 is a flow diagram showing a method of determining the cost value for each pair of modifications, as executed during the method of FIG. 19;

FIG. 21 is a flow diagram showing a method of determining a weighted value for sub-modifications of modifications, as executed during the method of FIG. 20.

FIG. 22 is a flow diagram showing a method of inserting a modification into the digital document of FIG. 3;

FIG. 23 shows a toolbar for use in modifying a digital document;

FIG. 24 shows a modification listing window for use in modifying a digital document;

FIG. 25 shows a page summary view window for use in modifying a digital document;

FIG. 26 is a flow diagram showing a method of selecting the text under the hot area under a modification selected using the modification listing window of FIG. 24;

FIG. 27 is a flow diagram showing a method of determining if a point p resides in a given triangle Tᵢ; and

FIG. 28 is a flow diagram showing a method of swapping vertices for use in optimising a triangulation.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or patent applicant that such documents or devices in any way form part of the common general knowledge in the art.

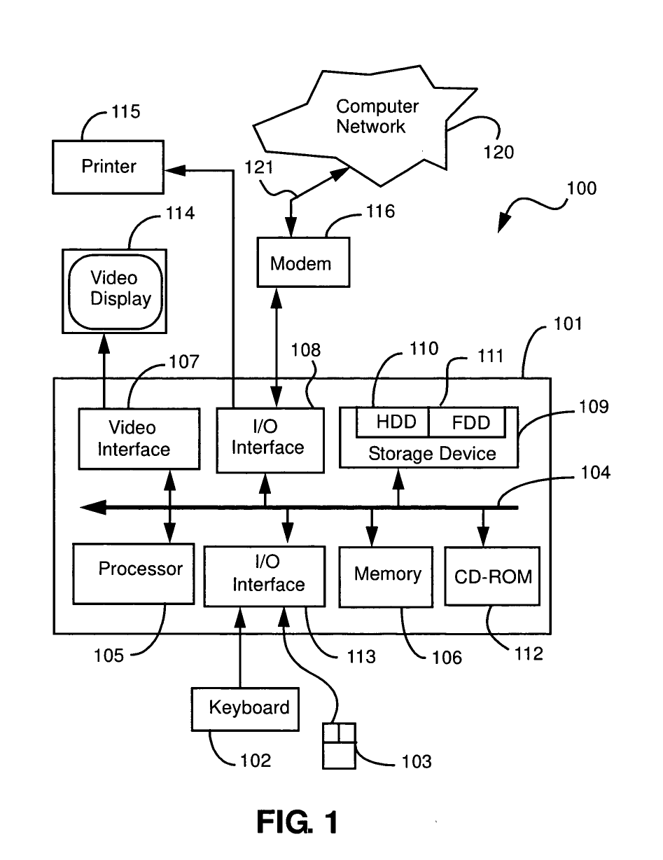

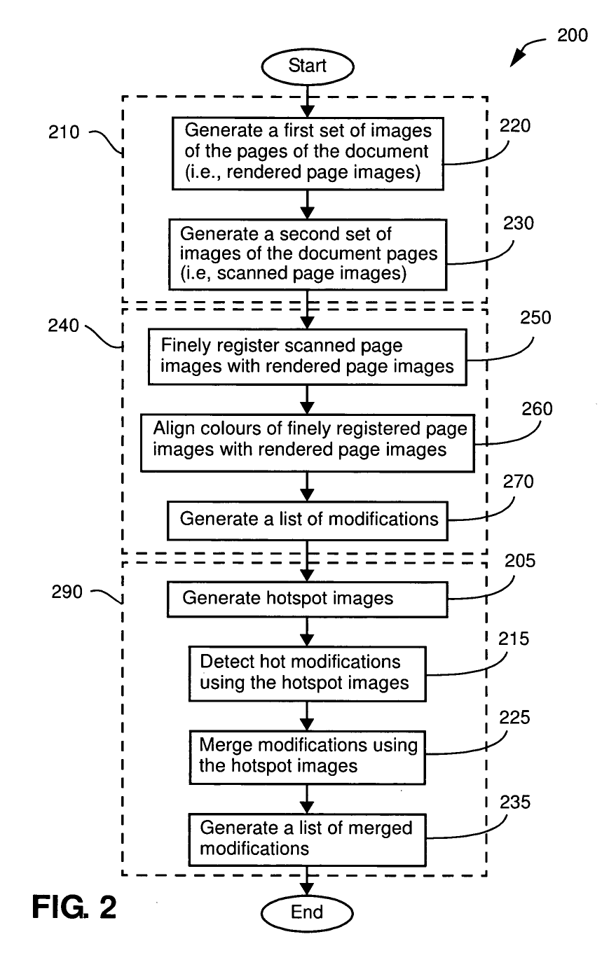

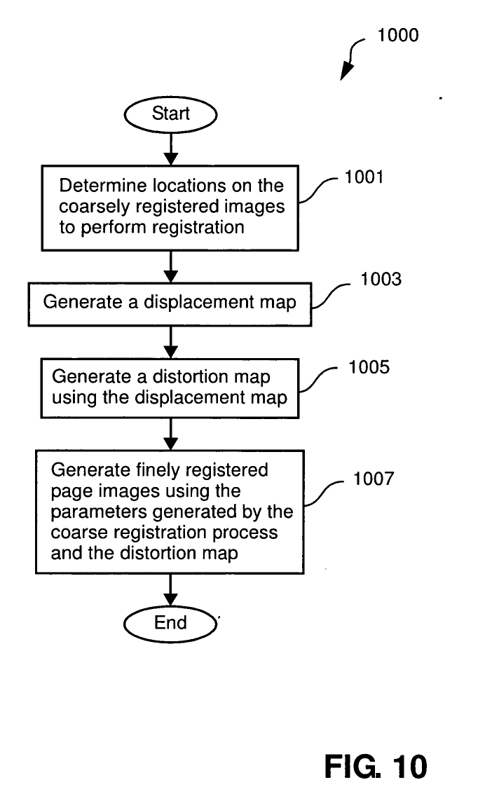

The methods described herein may be practiced using a general-purpose computer system 100, such as that shown in FIG. 1 wherein the processes of FIGS. 2 to 28 may be implemented as software, such as an application program executing within the computer system 100. In particular, the steps of described methods are effected by instructions in the software that are carried out by the computer. The instructions may be formed as one or more code modules, each for performing one or more particular tasks. For example, the software may be implemented as an add-in software module for any known word-processing application running on a windows system or any suitable operating system. The software may also be implemented as stand-alone document editing application software. The software may be divided into two separate parts, in which a first part performs the described methods and a second part manages a user interface between the first part and the user. The software may be stored in a computer readable medium, including the storage devices described below, for example. The software may be loaded into the computer from the computer readable medium, and then executed by the computer. A computer readable medium having such software or computer program recorded on it is a computer program product. The use of the computer program product in the computer preferably effects an advantageous apparatus for implementing the described methods.

The computer system 100 is formed by a computer module 101, input devices such as a keyboard 102 and mouse 103, output devices including a printer 115 and a display device 114. A Modulator-Demodulator (Modem) transceiver device 116 is used by the computer module 101 for communicating to and from a communications network 120, for example connectable via a telephone line 121 or other functional medium. The modem 116 can be used to obtain access to the Internet, and other network systems, such as a Local Area Network (LAN) or a Wide Area Network (WAN), and may be incorporated into the computer module 101 in some implementations.

The computer module 101 typically includes at least one processor unit 105, and a memory unit 106, for example formed from semiconductor random access memory (RAM) and read only memory (ROM). The module 101 also includes a number of input/output (I/O) interfaces including an audio-video interface 107 that couples to the video display 114, an I/O interface 113 for the keyboard 102 and mouse 103 and optionally a joystick (not illustrated), and an interface 108 for the modem 116 and printer 115. In some implementations, the modem 116 may be incorporated within the computer module 101, for example within the interface 108. A storage device 109 may be provided and typically includes a hard disk drive 110 and a floppy disk drive 111. A magnetic tape drive (not illustrated) may also be used. A CD-ROM drive 112 may be provided as a non-volatile source of data. The components 105 to 113 of the computer module 101, typically communicate via an interconnected bus 104 and in a manner which results in a conventional mode of operation of the computer system 100 known to those in the relevant art. Examples of computers on which the described arrangements can be practised include IBM-PC's and compatibles, Sun Sparcstations or alike computer systems evolved therefrom.

Typically, the application program is resident on the hard disk drive 110 and read and controlled in its execution by the processor 105. Intermediate storage of the program and any data fetched from the network 120 may be accomplished using the semiconductor memory 106, possibly in concert with the hard disk drive 110. In some instances, the application program may be supplied to the user encoded on a CD-ROM or floppy disk and read via the corresponding drive 112 or 111, or alternatively may be read by the user from the network 120 via the modem device 116. Still further, the software can also be loaded into the computer system 100 from other computer readable media. The term “computer readable medium” as used herein refers to any storage or transmission medium that participates in providing instructions and/or data to the computer system 100 for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the computer module 101. Examples of transmission media include radio or infra-red transmission channels as well as a network connection to another computer or networked device, and the Internet or Intranets including e-mail transmissions and information recorded on Websites and the like.

The described methods may alternatively be implemented in dedicated hardware such as one or more integrated circuits performing the functions or sub functions of FIGS. 2 to 28. Such dedicated hardware may include graphic processors, digital signal processors, or one or more microprocessors and associated memories.

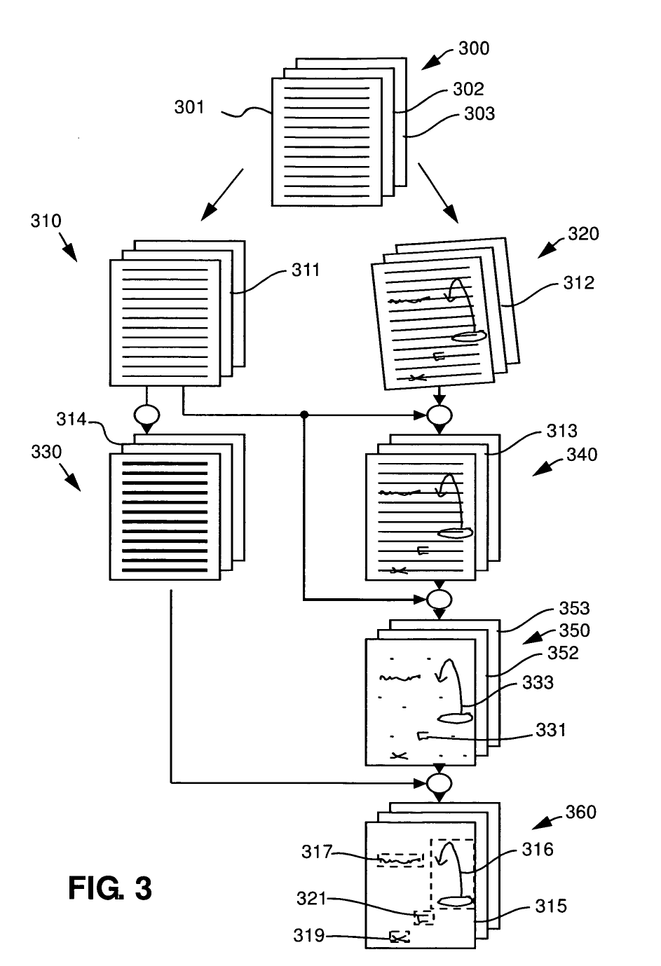

FIG. 2 is a flow diagram showing a method 200 of detecting modifications to a digital document. The method 200 will be described with reference to an example digital document 300, as seen in FIG. 3. The digital document 300 includes pages 301, 302 and 303, and may be generated using any document creation application, such as a word processing application. The method 200 collects and analyses data representing modifications to the document 300. This collection and analysis will be collectively referred to herein as “detection”. The method 200 may be implemented as software resident on the hard disk drive 10 and being controlled in its execution by the processor 105.

The method 200 begins at step 220 where the processor 105 generates a first set of images of the pages 301, 302 and 303 of the document 300. The first set of images represents the digital document 300 as the document 300 would appear if the document 300 was printed on paper, for example. An example of such a first set of images is shown in FIG. 3, and is referred to as “rendered page images” 310.

The rendered page images 310 may be generated by rendering a raster format (or bit map format) representation (e.g., 311) of each of the pages (e.g., 302) of the document 300 to memory 106 or the hard disk drive 110, during printing of the document 300. For example, an author of the digital document 300 may use the printer 115 to generate a hard copy of the document 300. The hard copy of the document 300 may be used to review the document 300. During the process of printing the document 300, the processor 105 may generate the rendered page images 310. The rendered page images 310 may be stored as one or more image files in memory 106 or on the hard disk drive 110. The rendered page images 310 may be associated with the digital document 300 by saving metadata, together with a digital document file comprising the digital document 300. In this instance, the metadata indicates the location of the image files in memory 106 or the storage device 109. The image files may also be stored in one or more remote servers (not shown) connected to the network 120. The rendered page images 310 may be retrieved by the processor 105 by reading the metadata in the digital document file and loading the image files from the location in memory 106 or the hard disk drive 110 indicated by the metadata.

The method 200 continues at the next step 230, where the processor 105 generates a second set of images 320. The second set of images 320 are images (e.g., 312) of modified (e.g., annotated and/or amended) pages of the document 300. An example of such a second set of images is also shown in FIG. 3 and is referred to as the “scanned page images” 320. The scanned page images 320 of FIG. 3 may be generated by scanning a modified (e.g., annotated or amended) hard copy of the pages 301, 302 and 303 of the document 300. Again, the scanned page images 320 may be stored as image files in memory 106 or on the hard disk drive 110. In one implementation, each image (e.g., 312) in the set of scanned page images 320 corresponds to a page (e.g., 302) of the document 300 for which a rendered page image (e.g., 311) of the rendered page images 310 has been generated.

Steps 220 and 230 of the method 200 may be considered to be sub-steps of a data collection step 210. In one implementation, the rendered page images 310 and the scanned page images 320 are generated at a resolution of two hundred (200) dots per inch (dpi). However, the rendered page images 310 and the scanned page images 320 may be generated at any suitable resolution.

Once the rendered page images 310 and the scanned page images 320 have been generated, the rendered page images 310 and the scanned page images 320 are analysed by the processor 105, at the next step 240. This analysis detects any differences between the rendered page images 310 and the scanned page images 320. These differences represent modifications made to a hard copy of the digital document 300. The analysis step 240 may be considered to comprise four sub-steps including an image registration step 250, a colour alignment step 260, and a modification list generating step 270. Each of these steps 250, 260 and 270, will now be described in more detail below, with reference to the example document 300 of FIG. 3.

As a result of the scanning of the modified hard copy of the document 300 to generate the scanned page images 320, the scanned page images 320 represent scaled, translated, rotated and warped representations of the rendered page images 310. The image registration step 250 aligns (or registers) the scanned page images 320 with the rendered page images 310. As will be described in detail below, to register the scanned page images 320 with the rendered page images 310, at step 250, the scanned page images 320 and the rendered page images 310 are blurred, and rotation, scale, and translation (“RST”) parameters are determined for the scanned page images 320. This is referred as coarse registration. Fine registration may then be performed on the scanned page images 320 to determine a warp map representing fine image distortion.

As will now be described, the registration step 250 accounts for gross registration errors and then accounts for small warps (e.g., scanner non-linearities). These small warps may not be constant over a page (e.g., 301).

Other than mis-registration and modifications, the images in the rendered page images 310 and the scanned page images 320 (e.g., images 311 and 312, respectively) may differ significantly. Some of these differences are unimportant to the modifications, such as differences between rendering in regard to half-toning or font selection. In order to reduce the difference between an image (e.g., 311) of the rendered page images 310 and a corresponding image (e.g., 312) of the scanned page images 320, without removing the modifications made to the hard copy of the document 300, both of the images 311 and 312 may be pre-filtered.

A Gaussian blur may be used to pre-filter the image 311 from the rendered page images 310 and the corresponding image (e.g., 312) of the scanned page images 320. In this instance, the Gaussian blur may have a kernel size of five (5) and a standard deviation of two (2). However, any suitable kernel size and standard deviation may be used.

After filtering using the Gaussian blur, the rotation, scale and translation (RST) parameters for the scanned page images 320 with respect to the rendered page images 310 are determined. The determination of the rotation, scale and translation (RST) parameters, as executed at step 250, will now be described by way of example for two images I₁(x,y) and I₂(x,y). However, any other suitable method for determining the rotation, scale and translation (RST) parameters for the scanned page images 320 may be used.

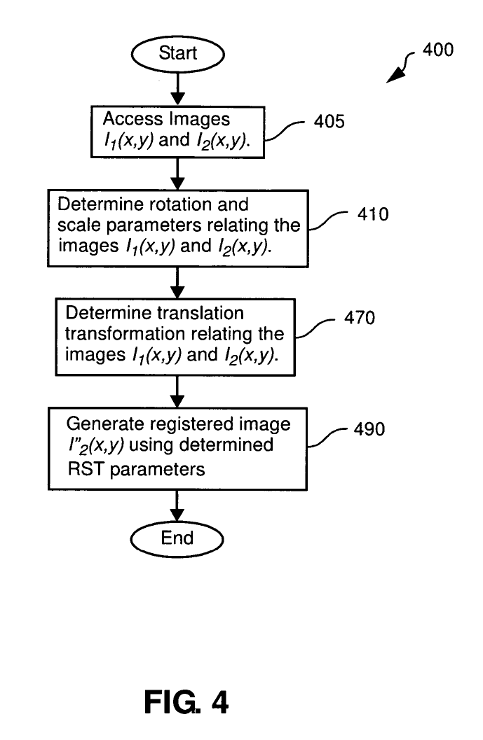

FIG. 4 is a flow diagram showing a method 400 of determining a coarsely registered image I″₂(x,y) using rotation, scale and translation (RST) parameters (θ,s,Δₓ,Δ_{y}) relating two images I₁(x,y) and I₂(x,y), as executed during step 250 of the method 200. The method 400 may be implemented as software resident on the hard disk drive 110 and being controlled in its execution by the processor 105. The images I₁(x,y) and I₂(x,y) may be stored in memory 106 or in the hard disk drive 110.

The method 400 begins at step 405, where the processor 105 accesses the two images I₁(x,y) and I₂(x,y), from memory 106 or the hard disk drive 110. The images I₁(x,y) and I₂(x,y) are assumed to have a substantial overlap in image content. The images I₁(x,y) and I₂(x,y) are functions with real values. As such, the images I₁(x,y) and I₂(x,y) may be represented by an array of values between zero (0) and a predetermined maximum value (e.g., one (1) or two hundred and fifty five (255)). The images I₁(x,y) and I₂(x,y) may be accessed from the hard disk drive 110 or floppy disk drive 111, at step 405. Alternatively, the images I₁(x,y) and I₂(x,y) may be downloaded over the network 120 from an imaging device (not illustrated) connected to the network 120.

The method 400 continues at the next step 410, where the processor 105 determines the rotation and scale parameters θ and s, respectively, which relate the two images I₁(x,y) and I₂(x,y). In the present example, the two images I₁(x,y) and I₂(x,y) are assumed to be related by rotation, scale and translation, as follows:
I₂(x,y)=I₁(s(x cos θ+y sin θ)+Δₓ,s(−x sin θ+y cos θ)+Δ_{y}) (1)
where s represents a scale factor, θ represents a rotation angle, and (Δₓ, Δ_{y}) represents the translation. The unknown scale and rotation translation parameters up to a one-hundred and eighty degrees (180°) ambiguity in the rotation angle θ is determined. A Fourier transform of the scaled, rotated and shifted image I₂(x,y) related to the image I₁(x,y) may be determined according to the following formula (2):

$$𝔍 [ {I}_{2} ] ( u , v ) = \frac{1}{{\vert s \vert}^{2}} 𝔍 [ {I}_{1} ] ( \frac{u cos ϑ + v sin ϑ}{s} , \frac{- u sin ϑ + v cos ϑ }{s} ) {e}^{2 π {iuΔ}_{x}} {e}^{2 π {iuΔ}_{y}} , \qquad ( 2 )$$

By determining the magnitude of the Fourier transform ℑ[I₂], a translation invariant of the image I₂(x,y) may be determined according to the following formula (3):

$$\vert 𝔍 [ {I}_{2} ] ( u , v ) \vert = \frac{1}{{\vert s \vert}^{2}} \vert 𝔍 [ {I}_{1} ] ( \frac{u cos ϑ + v sin ϑ}{s} , \frac{- u sin ϑ + v cos ϑ}{s} ) \vert . \qquad ( 3 )$$

The translation invariant of the image I₂(x,y) is not dependent on the translation (Δₓ,Δ_{y}) of the image I₂(x,y). Performing a log-polar transformation of the Fourier magnitude leads to a simple linear relationship between the Fourier magnitudes of the two images I₁(x,y) and I₂(x,y) according to the following formula (4):

$$\vert 𝔍 [ {I}_{2} ( x , y ) ] ( R , Φ ) \vert = \frac{1}{{\vert s \vert}^{2}} \vert 𝔍 [ {I}_{2} ( x , y ) ] ( R - log s , Φ + ϑ ) \vert \qquad ( 4 )$$

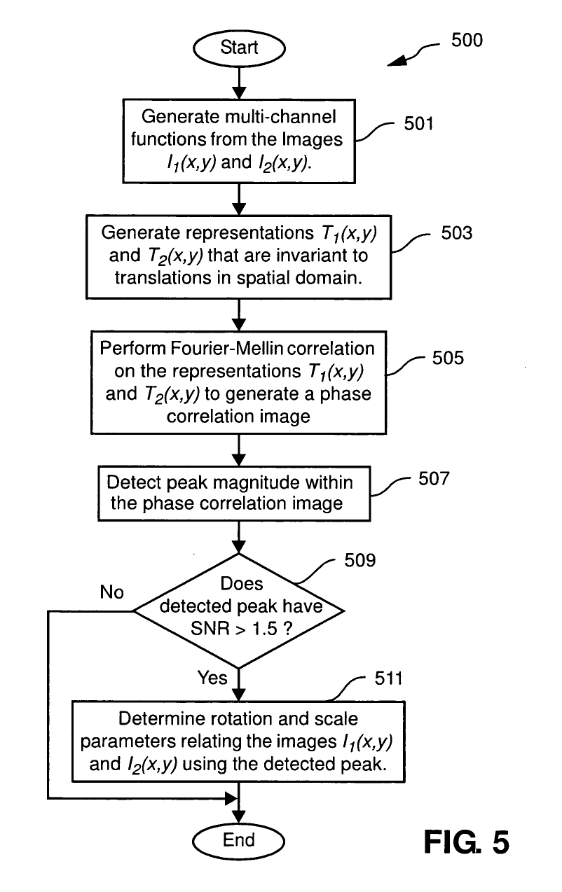

A correlation between a log-polar resampling of the Fourier magnitude of the two images I₁(x,y) and I₂(x,y) contains a peak at log s and θ, thereby allowing the unknown scale s and rotation angle θ parameters relating the two images I₁(x,y) and I₂(x,y) to be determined, with the rotation angle θ having one-hundred and eighty degrees (180°) ambiguity. This ambiguity is the result of the Fourier magnitude of a real function being symmetric. A method 500 of determining the rotation and scale parameters, θ and s respectively, which relate the two images I₁(x,y) and I₂(x,y), as executed at step 410, will be described below with reference to FIG. 5.

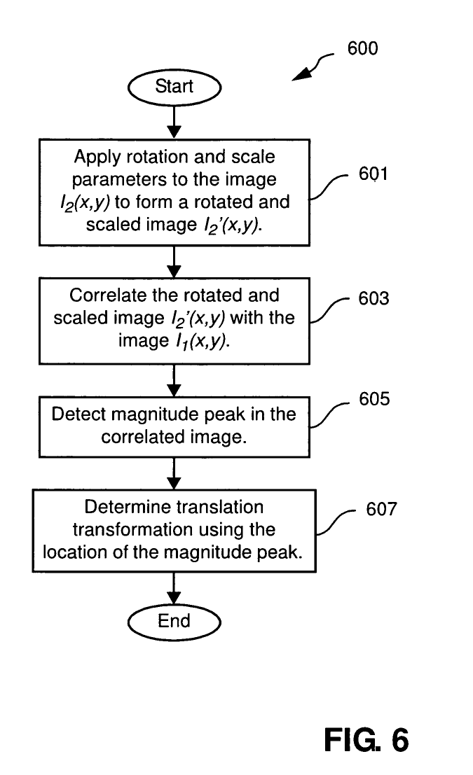

The method 400 continues at the next step 470, where the processor 105 determines the translation (Δₓ,Δ_{y}) relating the two images I₁(x,y) and I₂(x,y). The processor 105 determines the translation (Δₓ,Δ_{y}) by undoing the scale and rotation translations for possible rotation angles θ for the second image I₂(x,y) to produce a partially registered image. The partially registered image may then be correlated with the first image I₁(x,y) to determine the unknown translation (Δₓ,Δ_{y}) between the two images I₁(x,y) and I₂(x,y). The rotation angle θ that gives the best spatial correlation between the partially registered image and the first image I₁(x,y) is considered to be the correct rotation angle θ. Therefore, the complete translation (Δₓ,Δ_{y}) relating the two images I₁(x,y) and I₂(x,y) has been determined. A method 600 of determining the translation (Δₓ,Δ_{y}) relating the two images I₁(x,y) and I₂(x,y), as executed at step 470, will be described in detail below with reference to FIG. 6.

The method 400 concludes at the next step 490, where the processor 105 generates a coarsely registered image I″₂(x,y) by applying the RST parameters (θ,s,Δₓ,Δ_{y}) to the image I₂(x,y).

The method 500 of determining the rotation and scale parameters, θ and s respectively, which relate the two images I₁(x,y) and I₂(x,y), as executed at step 410, will now be described below with reference to FIG. 5. The method 500 may be implemented as software resident on the hard disk drive 110 and being controlled in its execution by the processor 105.

The method 500 begins at the first step 501, where the processor 105 generates a multi channel function(s) from the images I₁(x,y) and I₂(x,y). The multi channel function may be in the form of complex images \overline{I}₁(x,y) and \overline{I}₂(x,y) generated from the images I₁(x,y), and I₂(x,y). The processor 105 generates the complex images \overline{I}₁(x,y) and \overline{I}₂(x,y), at step 501, from the images I₁(x,y), and I₂(x,y), such that when each complex image \overline{I}ₙ(x,y) is Fourier transformed, a non-Hermitian result with a non-symmetric Fourier magnitude is generated. As will be described in detail below, using a complex image \overline{I}ₙ(x,y) as the input to a Fourier-Mellin correlation, a one-hundred and eighty degrees (180°) ambiguity between the images I₁(x,y), and I₂(x,y), which would otherwise exist, is removed.

The complex images \overline{I}₁(x,y) and \overline{I}₂(x,y) are generated at step 501 by applying an operator γ{ } to the images I₁(x,y), and I₂(x,y), where the operator γ{ } is commutative within a constant to rotation and scale, as follows:
Tβ,s[γ{ƒ(x,y)}]=g(β,s)γ{T_{β,s}[ƒ(x,y)]}; (5)
where β and s are rotation and scale factors, T_{β,s} is a rotation-scale transformation, and g is some function of rotation β and scale s.

Examples of the operator γ{ } include the following:

$$\begin{matrix}γ \{ f ( x , y ) \} = f ( x , y ) + {if}^{2} ( x , y ) ; & ( 6 ) \\ γ \{ f ( x , y ) \} = \frac{\partial f}{\partial x} + i \frac{\partial f}{\partial y} ; and & ( 7 ) \\ γ \{ f ( x , y ) \} = {( \frac{\partial f}{\partial x} + i \frac{\partial f}{\partial y} )}^{2} . & ( 8 )\end{matrix}$$

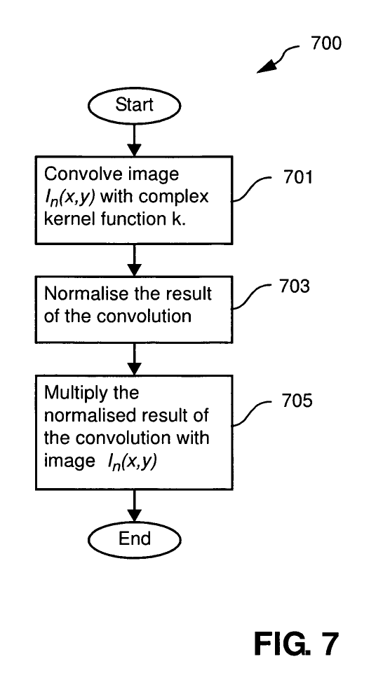

A method 700 of generating a complex image \overline{I}ₙ(x,y) from an image Iₙ(x,y), as executed at step 501, will be described below with reference to FIG. 7.

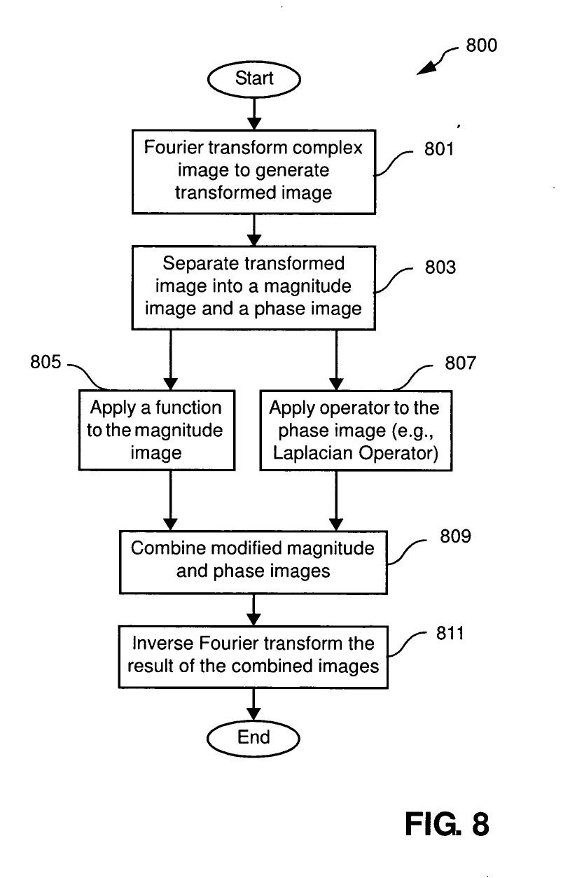

The multi-channel functions (i.e., the complex images \overline{I}₁(x,y) and \overline{I}₂(x,y)) generated at step 501, are then processed by the processor 105 at the next step 503 to generate a representation T₁(x,y) and T₂(x,y) of each of the two complex images \overline{I}₁(x,y) and \overline{I}₂(x,y), respectively, where the representations T₁(x,y) and T₂(x,y) are substantially translation invariant in the spatial domain. A method 800 of generating a representation T₁(x,y) and T₂(x,y) of each of the two complex images \overline{I}₁(x,y) and \overline{I}₂(x,y), as executed at step 503, where the representations T₁(x,y) and T₂(x,y) are substantially translation invariant in the spatial domain, will be described below with reference to FIG. 8.

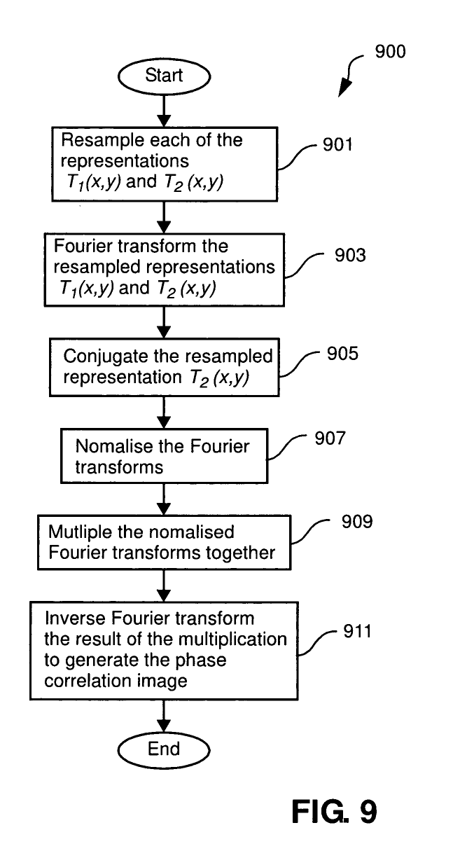

At the next step 505, the processor 105 performs Fourier-Mellin correlation on the representations T₁(x,y) and T₂(x,y) of the two complex images \overline{I}₁(x,y) and \overline{I}₂(x,y), to generate a phase correlation image. Rotation and scaling relate the input images I₁(x,y) and I₂(x,y) are represented in the generated phase correlation image by isolated peaks. A method 900 of performing Fourier-Mellin correlation, as executed at step 505, will be described below with reference to FIG. 9. Since the representations T₁(x,y) and T₂(x,y) are translation invariant in the spatial domain, the Fourier-Mellin correlation produces superior results for images I₁(x,y) and I₂(x,y) that are related by a wide range of translation, rotation and scale factors. Such superior results typically include increased matched filter signal to noise ratio (SNR) for images that are related by rotation, scale and translation parameters, and enhanced discrimination between images that are not related by rotation, scale and translation parameters.

The method 500 continues at the next step 507 where the processor 105 detects the location of a magnitude peak within the phase correlation image. The location of the magnitude peak may be interpolated through quadratic fitting to detect the location of the magnitude peak to sub-pixel accuracy. At the next step 509, the processor 105 then determines whether the detected magnitude peak has a signal to noise ratio (SNR) that is greater than a predetermined threshold (e.g., one point five (1.5)).

If the processor 105 determines at step 509 that the determined peak has a signal to noise ratio (SNR) that is not greater than the predetermined threshold, then the images I₁(x,y) and I₂(x,y) are not related by rotation and scale parameters, and the method 500 concludes. Otherwise, if the processor 105 determines that the magnitude peak has a signal to noise ratio that is greater than the predetermined threshold, then at the next step 511 the processor 105 uses the location of the magnitude peak to determine the scale s and rotation angle θ parameters relating the two images I₁(x,y) and I₂(x,y). If the magnitude peak is at location (ζ,α), then the scale s and rotation angle θ parameters which relate the two images I₁(x,y) and I₂(x,y) may be determined according to the following formulas (9) and (10):

$$\begin{matrix}s = {e}^{- a ζ} , and & ( 9 ) \\ ϑ = \frac{2 πα}{Q} . & ( 10 )\end{matrix}$$

where a and Q are constants. The constants a and Q are related to a log-polar resampling step of a method 900 of performing Fourier-Mellin correlation, which will be described below with reference to FIG. 9.

The method 600 of determining the translation (Δₓ,Δ_{y}) relating the two images I₁(x,y) and I₂(x,y), as executed at step 470, will now be described in detail below with reference to FIG. 6. The method 600 may be implemented as software resident on the hard disk drive 110 and being controlled in its execution by the processor 105.

The method 600 begins at the next step 601, where the scale s and rotation angle θ parameters, determined by the method 500, are applied to the image I₂(x,y), to form a rotated and scaled image I′₂(x,y). Alternatively, the inverse of the scale s and rotation angle θ parameters, determined by the method 500, may be applied to the complex image \overline{I}₁(x,y) to form the rotated and scaled image I′₁(x,y). The rotated and scaled image I′₂(x,y) and the image I₁(x,y) are then correlated by the processor 105 at the next step 603, using phase correlation, to produce a correlated image. Alternatively, the rotated and scaled image I′₁(x,y) and the image I₂(x,y) may be correlated at step 603. The position of a magnitude peak in the correlation image will generally correspond to the translation (Δₓ,Δ_{y}) relating the images I₁(x,y), and I₂(x,y). Accordingly, at the next step 605 the processor 105 detects the location of the magnitude peak within the correlated image.

At the next step 607, the processor 105 uses the location of the magnitude peak determined at step 605 to determine the translation (Δₓ,Δ_{y}) relating the two images I′₁(x,y) and I₂′(x,y). The same translation (Δₓ,Δ_{y}) also relates the two images I₁(x,y) and I₂(x,y). If the magnitude peak is at location (x₀,y₀), then the translation (Δₓ,Δ_{y}) is (−x₀,−y₀). Thus, the unknown scale s and rotation angle θ parameters have been determined by the method 500, and the unknown translation (Δₓ,Δ_{y}) has been determined in step 607. The determined rotation, scale and translation parameters (θ,s,Δₓ,Δ_{y}) may then be used to determine the registered image I₂(x,y), as at step 490.

The method 700 of generating a complex image \overline{I}ₙ(x,y) from an image Iₙ(x,y), as executed at step 501, will now be described below with reference to FIG. 7. The method 700 may be executed as software resident on the hard disk drive and being controlled in its execution by the processor 105.

The method 700 begins at the first step 701, where the image Iₙ(x,y) is convolved with a complex kernel function k by the processor 105. The convolution may be performed in the spatial domain or through multiplication in the Fourier domain. The complex kernel function k used in step 701 is a kernel with the property that the Fourier transform K=ℑ(k) is of the formula (11):

$$K ( u , v ) = \frac{u + iv}{\vert u + iv \vert} . \qquad ( 11 )$$

The result of the convolution ((I*k), where * denotes convolution,) is normalised at the next step 703 to have unit magnitude according to the following formula (12),

$$Γ = \frac{I * k}{\vert I * k \vert} , \qquad ( 12 )$$

The normalised result of the convolution F is multiplied with the image Iₙ(x,y) at the next step 705 to generate the complex image \overline{I}ₙ(x,y). The complex image \overline{I}ₙ(x,y) has the same magnitude as the image Iₙ(x,y), but each point in the complex image \overline{I}ₙ(x,y) has an associated phase generated by the convolution at step 701. For the kernels k and k′ given in formulas (11) and (12), the associated phase encodes a quantity related to the gradient direction of the image Iₙ(x,y).

The method 800 of generating a representation T₁(x,y) and T₂(x,y) of each of the two complex images \overline{I}₁(x,y) and \overline{I}₂(x,y), as executed at step 503, will now be described. The representations T₁(x,y) and T₂(x,y) are substantially translation invariant in the spatial domain. The method 800 receives as input the complex images \overline{I}ₙ(x,y) (i.e., \overline{I}₁(x,y) and \overline{I}₂(x,y)) formed in step 501. The method 800 begins at step 801 where the complex images \overline{I}ₙ(x,y) are Fourier transformed by the processor 105, using the fast Fourier transform (FFT), to produce an image comprising complex values. At the next step 803, the transformed image generated at step 801 is separated into a magnitude image comprising the magnitudes of the complex values of the Fourier transform, and a phase image comprising the phases of the complex values of the Fourier transform. Then at the next step 805, a function is applied to the magnitude image, with the function being commutative within a constant to rotation and scale. The magnitude image may be multiplied by a ramp function at step 805 to perform high-pass filtering of the magnitude image. At step 807, as seen in FIG. 8, an operator is applied to the phase image to take the second or higher derivative of the phase, which is a translation invariant. The Laplacian operator may be used at step 807.

The method 800 continues at the next step 809, where the modified magnitude image produced at step 805, and the result of determining the Laplacian of the phase image produced at step 807 are combined by the processor 105 using the following formula (13):
|F|+iA∇²φ (13)
where |F| represents the modified magnitudes of the Fourier transform of the complex images \overline{I}ₙ(x,y), ∇²φ represents the Laplacian of the phase image of the Fourier transform and A represents a scaling constant determined according to the following formula (14):
A=max(|F|)/π (14)
The scaling constant A ensures that the recombined Fourier magnitude and phase images are of substantially equal magnitude.

The result of combining the modified magnitude image and the result of taking the Laplacian of the phase image is then inverse Fourier transformed at the next step 811, to produce the representations Tₙ(x,y) (i.e., T₁(x,y) and T₂(x,y)). The representations Tₙ(x,y) is translation invariant in the spatial domain. Other translation invariants of the Fourier magnitude and phase may be used in place of sub-steps 805 and 809. For example, the phase may be set to zero (0).

The method 900 of performing Fourier-Mellin correlation, as executed at step 505, will now be described with reference to FIG. 9. The method 900 may be implemented as software resident on the hard disk drive 110 and being controlled in its execution by the processor 105. The Fourier-Mellin correlation is performed on the representations T₁(x,y) and T₂(x,y) that are translation invariant in the spatial domain.

The method 900 begins at step 901, where each of the representations T₁(x,y) and T₂(x,y) are resampled to the log-polar domain. In order to resample to the log-polar domain, a resolution within the log-polar domain is specified. If the images I₁(x,y) and I₂(x,y) are N pixels wide by M pixels high (i.e., the coordinate x varies between 0 and N−1, while the y-coordinate varies between 0 and M−1), then the centres of the representations T₁(x,y) and T₂(x,y) which are translation invariant in the spatial domain are located at (cₓ,c_{y})=(floor(N/2), floor(M/2)). Log-polar resampling to an image having dimensions P pixels by Q pixels in log-polar space is performed relative to the centres of the representations T₁(x,y) and T₂(x,y). To avoid a singularity at the origin, a disc of radius rₘᵢₙ pixels around the centres of the representations T₁(x,y) and T₂(x,y) is ignored. While ignoring this disc, a point (i,j) in the log-polar plane may be determined by interpolating the translation invariant representations T₁(x,y) and T₂(x,y) at the point (x,y) using the following formulas (15), (16) and (17):

$$\begin{matrix}x = {c}_{x} + cos \frac{2 π j}{Q} {r}_{min} {e}^{ai} \\ y = {c}_{y} + sin \frac{2 π j}{Q} {r}_{min} {e}^{ai} \\ where & ( 15 ) \\ a = \frac{log {r}_{max} / {r}_{min}}{P - 1} \\ and \\ & ( 16 ) \\ {r}_{max} = max \{ M / 2 , N / 2 \} & ( 17 )\end{matrix}$$

denotes the maximum radius in the spatial domain that the log-polar image extends to. Common values of the constants rₘᵢₙ, P and Q are determined using the following formulas (18) and (19):
P=Q=(M+N)/2, and (18)
r=5, (19)

At the next step 903, the processor 105 performs the Fourier transform on each of the resampled representations T₁(x,y) and T₂(x,y). Then at the next step 905, the processor 105 performs a complex conjugation on the second resampled representation T₂(x,y). The Fourier transforms generated at step 903 are then normalised at the next step 907 so that each Fourier transform has unit magnitude by dividing each complex element of each Fourier transform by the magnitude of the complex element. The normalised Fourier transforms are then multiplied together at the next step 909 and the result of the multiplication is then inverse Fourier transformed at sub-step 911 to generate a phase correlation image.

The method 400 of determining a translation (Δₓ,Δ_{y}) relating two images has been described in terms of operations on images I₁(x,y) and I₂(x,y) that have only one component. The method 400 may be applied to colour images with multiple components by assuming that each channel in an image undergoes approximately the same distortion. In this instance, to determine the rotation, scale and translation (RST) parameters, the method 400 may be performed on the luminance component of images, using the determined RST values for all channels.

Returning now to the method 200, the rotation, scaling, and translation (RST) parameters determined in accordance with the method 400 may be applied to the scanned page images 320 at step 250 to generate coarsely registered scanned page images. The rotation, scaling, and translation (RST) parameters may be applied to blocks of a particular scanned page image (e.g., 312) as the particular image is required for fine registration.

In order to complete step 250 of the method 200, a fine image registration may then be performed on the coarsely registered scanned page images to undo residual transforms, which exist in the coarsely registered scanned page images. The result of this fine registration is finely registered page images 340 as seen in FIG. 3. The finely registered page images 340 may be stored in memory 106 or in the hard disk drive 110.

A method 1000 of performing fine registration on the coarsely registered scanned page images, as executed during step 250, to generate finely registered page images 340, will now be described in detail. The method 1000 may be implemented as software resident on the hard disk drive 110 and being controlled in its execution by the processor 105.

The method 1000 begins at step 1001, where the processor 105 determines appropriate locations on the coarsely registered page images to perform registration. Registration is only performed at locations on a particular coarsely registered page image where there are a sufficient amount of features in a corresponding location on a corresponding rendered page image (e.g., 311) to enable the particular coarsely registered page image to be matched with the corresponding rendered page image. Corner detection may be used to determine locations on the rendered page images 310 where there are sufficient features to enable matching.

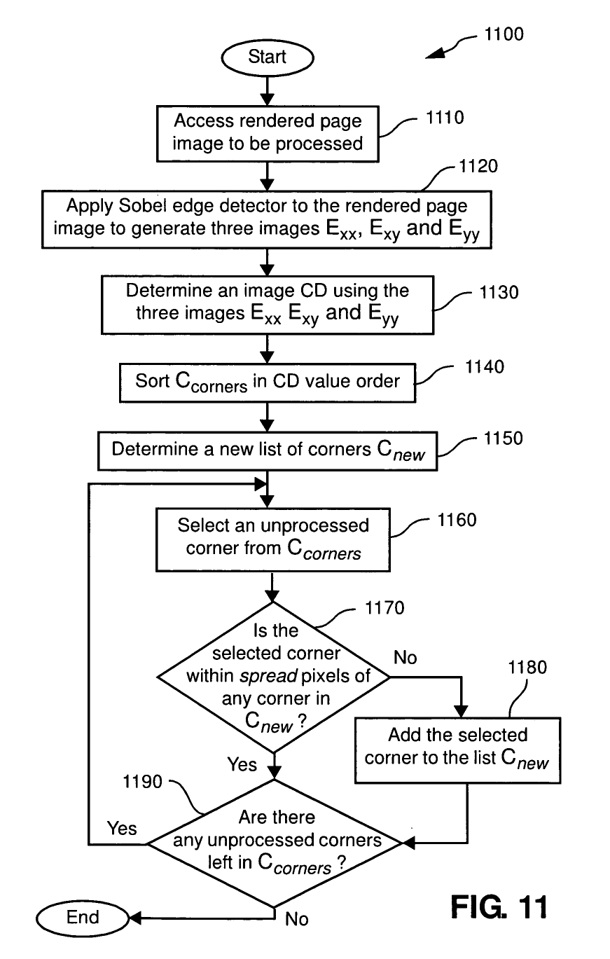

A method 1100 of performing corner detection to determine locations on the rendered page image 310 where there are sufficient features to enable matching, as executed at step 1001 of the method 1000, will now be described in detail below with reference to FIG. 11.

The method 1100 begins at step 1110, where the processor 105 accesses a page image (e.g., 311) from the rendered page images 310 stored in memory 106 or the hard disk drive 110. At the next step 1120, the processor 205 applies a Sobel edge detector to the accessed rendered page image 311. The Sobel edge detector is applied to the rendered page image 311 in both the x and the y axes. The Sobel detector uses the following kernels (20):

$${S}_{x} = [ \begin{matrix}- 1 & 0 & 1 \\ - 2 & 0 & 2 \\ - 1 & 0 & 1\end{matrix} ] \\ {S}_{y} = [ \begin{matrix}- 1 & - 2 & - 1 \\ 0 & 0 & 0 \\ 1 & 2 & 1\end{matrix} ] \qquad ( 20 )$$

Edge detection may be performed according to the following formulas (21):
Eₓ=Sₓ*I
E_{y}=S_{y}*I (21)
where * is the convolution operator, I is the image data, Sₓ,S_{y} are the kernels defined above, and Eₓ,E_{y} are images containing the strength of the edges in the x and y direction respectively. From Eₓ,E_{y}, three images may be determined according to the following formulas (22):
Eₓₓ=Eₓ∘Eₓ
E_{xy}=Eₓ∘E_{y}
E_{yy}=E_{y}∘E_{y} (22)
where ∘ represents a pixel-wise multiplication.

A low pass filter operation (e.g., a box filter with a kernel size of three (3)) may be performed on the images Eₓₓ,E_{xy},E_{yy} to reduce the effect of noise.

The method 1100 then continues at the next step 1130, where the processor 105 determines an image CD and performs local maxima detection on the image CD to determine a list of corner points in the image CD. To detect whether a point is a corner, the image CD may be determined according to the following formula (23):

$$CD = \frac{( {E}_{xx} {E}_{yy} - 2 {E}_{xy )}}{( {E}_{xx} + {E}_{yy} )} \qquad ( 23 )$$

The resulting image CD is a measure of the likelihood that each pixel Eₓₓ,E_{xy},E_{yy} is a corner. A particular pixel is classified as a corner pixel if the pixel is the local maximum in the eight pixel neighbourhood of the pixel. That is, a pixel at location (x, y) is determined to be a corner point if
CD_{x,y}>CD_{x+1,y-1},CD_{x,y-1},CD_{x-1,y-1},CD_{x+1,y},CD_{x-1,y},CD_{x+1,y+1},CD_{x,y+1},CD_{x-1,y+1},
The processor 105 generates the list of the corner points detected, C_{corners}, together with a strength at the point CD_{x,y}, which are stored in memory 106 or the hard disk drive 110. The list of corner points, C_{corners}, may be further filtered by deleting points which are within spread pixels (e.g., spread=64) of another corner point, as will be described below in steps 1140 to 1190.

The method 1100 continues at the next step 1140, where the list of corners C_{corners} is sorted by the processor 105 in order of determined CD value at each point of the list of corners C_{corners}. Then at the next step 1150, the processor 105 determines a new list of corners, C_{new}, which is stored in memory 106 or the hard disk drive 110. The new list of corners, C_{new} represents the locations on the rendered page image 310 where there are sufficient features to enable matching. At the next step 1160, the processor 105 selects an unprocessed corner from the list of corners C_{corners}.

The method 1100 continues at the next step 1170, where the selected corner is compared to the corners in the new list C_{new}. If the corner selected at step 1160 is within spread pixels of a corner in C_{new}, then the method 1100 proceeds directly to step 1190. If the selected corner is not within spread pixels of a corner in C_{new}, the selected corner is added to the list C_{new} at the next step 1180. At step 1190, if the processor 105 determines that there are corners left to be processed in C_{corners}, the method 1100 returns to step 1160. Otherwise, the method 1100 concludes.

Returning to the method 1000, once the locations on the rendered page image 310 where there are sufficient features to enable matching have been determined, at the next step 1003, the processor 105 performs block based correlation to generate a displacement map. The displacement map represents warp that is required to map the pixels of the coarsely registered scanned page images to the rendered page image 311 of the rendered page images 310.

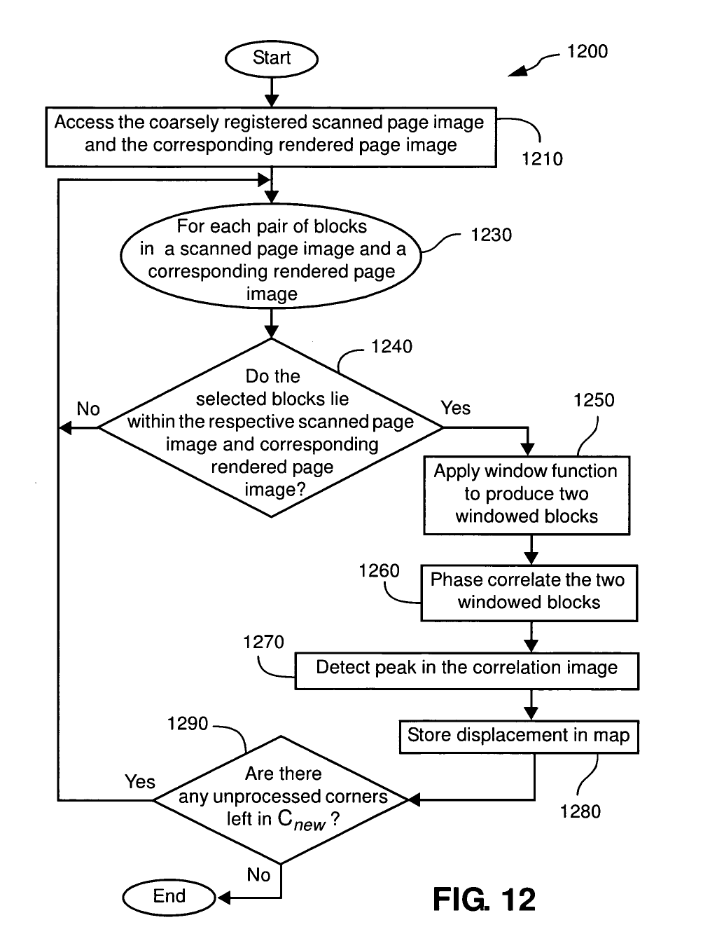

A method 1200 of determining a displacement map, as executed at step 1003, will now be described in detail with reference to FIG. 12. The method 1200 may be implemented as software resident on the hard disk drive 110 and being controlled in its execution by the processor 105.

The method 1200 begins at step 1210, where the processor 105 accesses a coarsely registered scanned page image from memory 106 or the hard disk drive 110. The coarsely registered scanned page image is N pixels wide and M pixels high. The processor 105 also accesses a corresponding rendered page image (e.g., 311), which is also N pixels wide and M pixels high. The processor 105 may assume that the coarsely registered scanned page image and the rendered page image 311 will be roughly registered to within a few pixels of each other.

Block based processing depends on the choice of a block size, Q. The precise value of Q is flexible. In one implementation, Q may be selected to be equal to two-hundred and fifty-six (256), representing a block two-hundred and fifty-six (256) pixels high by two-hundred and fifty-six (256) pixels wide. A block correlation is performed at each of the corner locations listed in the list of corners C_{new}. Block correlation is performed by comparing a selected block of the rendered page image 311 and a corresponding block of the coarsely registered scanned page image centring the blocks at the corner location in each of the images. The output of the block based correlation is a displacement map, D, which is a list of displacement vectors at the corner locations in the list of corners C_{new}. Each displacement vector and confidence estimate, which are then stored in a displacement map configured within memory 106 or the hard disk drive 110, is the result of a block correlation.

Registering of the images begins by entering a loop 1230 for each block pair of the rendered page image 311 and the coarsely registered scanned page image. The loop 1230 concludes when there are no unprocessed corners in the list of corners C_{new}. At step 1240, if the processor 205 determines that the selected blocks do not lie wholly within their respective rendered page image 311 and coarsely registered scanned page image, a confidence estimate of pixel (i, j) in D is set to zero (0) and the loop 1230 continues. Otherwise, the method 1200 proceeds to step 1250 where the processor 105 copies Y colour components from a YUV colour space version of red, green and blue (RGB) values of each block into a new image configured within memory 106 or the hard disk drive 110. The new image is then multiplied by a window function (e.g., a Harming window squared, in the vertical direction and again in the horizontal direction) to produce two windowed blocks.

The two windowed blocks are then correlated at the next step 1260. The correlation may be performed using phase correlation, in which the fast Fourier transform (FFT) of the first of the windowed blocks is multiplied by the complex conjugate of the fast Fourier transform (FFT) of the second of the windowed blocks, and the result of the multiplication is normalised to have unit magnitude. The result of this normalisation step has an inverse fast Fourier transform (FFT) applied by the processor 105, resulting in a correlation image, C, which may be stored in memory 106 or the hard disk drive 110. The correlation image C is a raster array of complex values. At the next step 1270, the processor 105 uses the correlation image to determine the location of the highest peak in the selected block, relative to the centre of the block, to sub-pixel accuracy. Then at the next step 1280, if the height of the highest peak divided by the height of the second highest peak is larger than a predetermined threshold (e.g., two (2)), then the sub-pixel accurate location relative to the centre of the block is stored in the displacement map, configured within memory 106, along with the square root of the peak height as a confidence estimate of the result of the correlation. Otherwise, the corner is deleted from the list of corners C_{new}. At the next step 1290, if the processor 105 determines that there are any more unprocessed corners left in the list of corners C_{new}, then the method 1200 returns to step to process. Otherwise, the method 1200 concludes.

The method 1000 of performing fine registration on the coarsely registered scanned page images, continues at the next step 1005, where the processor 105 uses the displacement map configured in memory 106 to generate a distortion map that relates each pixel in the coarsely registered scanned page image 312 to a pixel in the coordinate space of the corresponding rendered page image 311. Some parts of the distortion map may map pixels in the coarsely registered scanned page image 312 to pixels outside the boundary of the rendered page image 311. The mapping of pixels outside the boundary of the rendered page image 311 occurs since an imaging device used to produce the scanned page image 312 may not have imaged the entire corresponding page (e.g., 302) of the document 300.

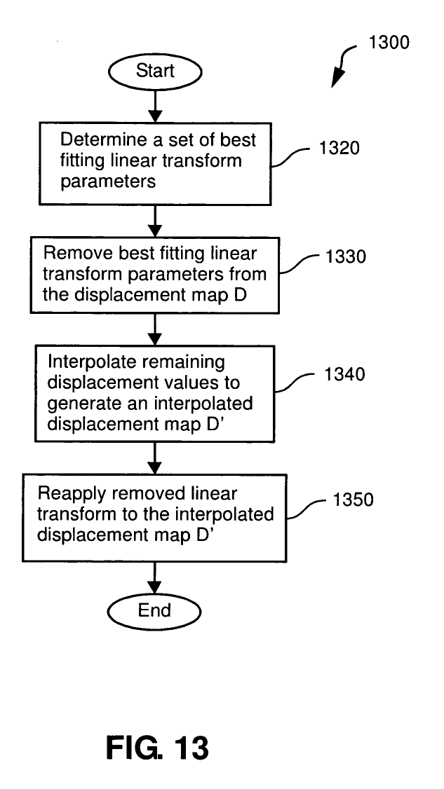

A method 1300 of generating a distortion image, as executed at step 1005, will now be described with reference to FIG. 13. The method 1300 may be implemented as software resident on the hard disk drive 110 and being controlled in its execution by the processor 105.

The method 1300 begins at step 1301, where the processor 105 retrieves the displacement map D from memory 106 or the hard disk drive 110 and determines a set of linear translation parameters, (b₁₁,b₁₂,b₂₁,b₂₂,Δx,Δy), that best fit the displacement map D. Undistorted points in the rendered page images 310 are labelled (xᵢ,yᵢ) for corner i in the displacement map D. These points are displaced by the displacement map D to give displaced coordinates, (\hat{x}ᵢ,ŷᵢ), determined according to the following formula (24):
(\hat{x}ᵢ,ŷᵢ)=(xᵢ,yᵢ)−D(i), (24)
where D(i) is the displacement vector part of the displacement map D. The linear translation parameters, acting on the undistorted points give affine transformed points, (\tilde{x}ᵢⱼ,\tilde{y}ᵢⱼ), according to the following formula (25):

$$( \begin{matrix}{\tilde{x}}_{1} \\ {\tilde{y}}_{1}\end{matrix} ) = ( \begin{matrix}{b}_{11} & {b}_{21} \\ {b}_{12} & {b}_{21}\end{matrix} ) ( \begin{matrix}{x}_{1} \\ {y}_{1}\end{matrix} ) + ( \begin{matrix}Δ x \\ Δ y\end{matrix} ) . \qquad ( 25 )$$

A best fitting affine transformation is determined so as to minimise error between the displaced coordinates, (\hat{x}ᵢ,ŷᵢ), and the affine transformed points (\tilde{x}ᵢ,\tilde{y}ᵢ) by changing the affine transform parameters. An error function to be minimised (e.g., the Euclidean norm measure E) may be determined according to the following formula (26):

$$E = {\sum }_{n = 1}^{N} {( {\hat{x}}_{n} - {\tilde{x}}_{n} )}^{2} + {( {\hat{y}}_{n} - {\tilde{y}}_{n} )}^{2} \qquad ( 26 )$$

The minimising solution may be determined according to the following formulas (27) to (31):

$$\begin{matrix}( \begin{matrix}{b}_{11} \\ {b}_{12} \\ Δ x\end{matrix} ) = {M}^{- 1} ( \begin{matrix}\sum {\hat{x}}_{n} {x}_{n} \\ \sum {\hat{x}}_{n} {x}_{n} \\ \sum {\hat{x}}_{n}\end{matrix} ) & ( 27 ) \\ ( \begin{matrix}{b}_{21} \\ {b}_{22} \\ Δ y\end{matrix} ) = {M}^{- 1} ( \begin{matrix}\sum {\hat{y}}_{n} {x}_{n} \\ \sum {\hat{y}}_{n} {y}_{n} \\ \sum {\hat{y}}_{n}\end{matrix} ) with & ( 28 ) \\ M = ( \begin{matrix}{S}_{xx} & {S}_{xy} & {S}_{x} \\ {S}_{xy} & {S}_{yy} & {S}_{y} \\ {S}_{x} & {S}_{y} & S\end{matrix} ) = ( \begin{matrix}\sum {x}_{n} {x}_{n} & \sum {x}_{n} {y}_{n} & \sum {x}_{n} \\ \sum {y}_{n} {x}_{n} & \sum {y}_{n} {y}_{n} & \sum {y}_{n} \\ \sum {x}_{n} & \sum {y}_{n} & \sum 1\end{matrix} ) & ( 29 ) \\ {M}^{- 1} = \frac{1}{\vert M \vert} ( \begin{matrix}- {S}_{y} {S}_{y} + {SS}_{yy} & - {SS}_{xy} + {S}_{x} {S}_{y} & {S}_{xy} {S}_{y} - {S}_{x} {S}_{yy} \\ - {SS}_{xy} + {S}_{x} {S}_{y} & - {S}_{x} {S}_{x} + {SS}_{xx} & {S}_{x} {S}_{xy} - {S}_{xx} {S}_{y} \\ {S}_{xy} {S}_{y} - {S}_{x} {S}_{yy} & {S}_{x} {S}_{xy} - {S}_{xx} {S}_{y} & - {S}_{xy} {S}_{xy} + {S}_{xx} {S}_{yy}\end{matrix} ) & ( 30 ) \\ and & \\ \vert M \vert = det M \\ = - S {S}_{xy} {S}_{xy} + 2 {S}_{x} {S}_{xy} {S}_{y} - {S}_{xx} {S}_{y} {S}_{y} - {S}_{x} {S}_{x} {S}_{yy} + {SS}_{xx} {S}_{yy} & ( 31 )\end{matrix}$$

where the sums S are carried out over all displacement pixels with non-zero confidence estimates on the displacement vectors in the displacement map D.

The method 1300 continues at the next step 1330, where the best fitting linear transformation is removed from the displacement map D. Each displacement map pixel is replaced according to the following formula (32):

$${D}_{residual} ( i ) \to D ( i ) - ( \begin{matrix}{b}_{11} & {b}_{21} \\ {b}_{12} & {b}_{22}\end{matrix} ) ( \begin{matrix}{x}_{i} \\ {y}_{i}\end{matrix} ) - ( \begin{matrix}Δ x \\ Δ y\end{matrix} ) \qquad ( 32 )$$

The displacement map D with the best fitting linear transform removed is then interpolated at the next step 1340. The displacement value for a given point is determined based on an interpolation method (e.g., triangulation). However, other interpolation methods may be used.

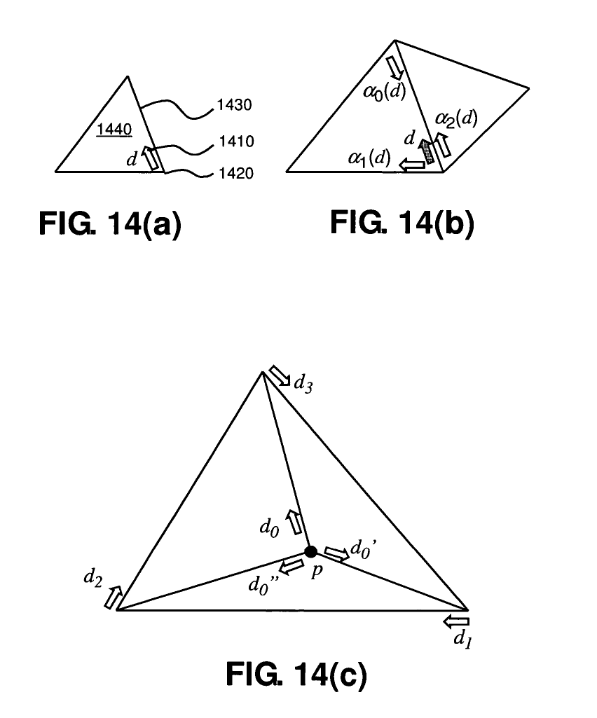

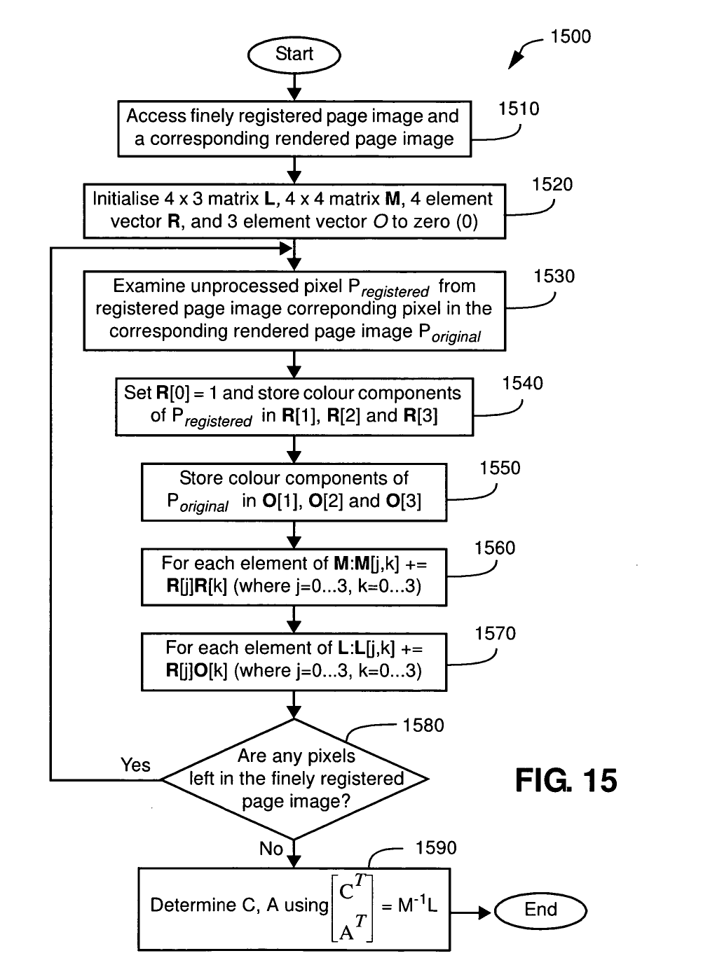

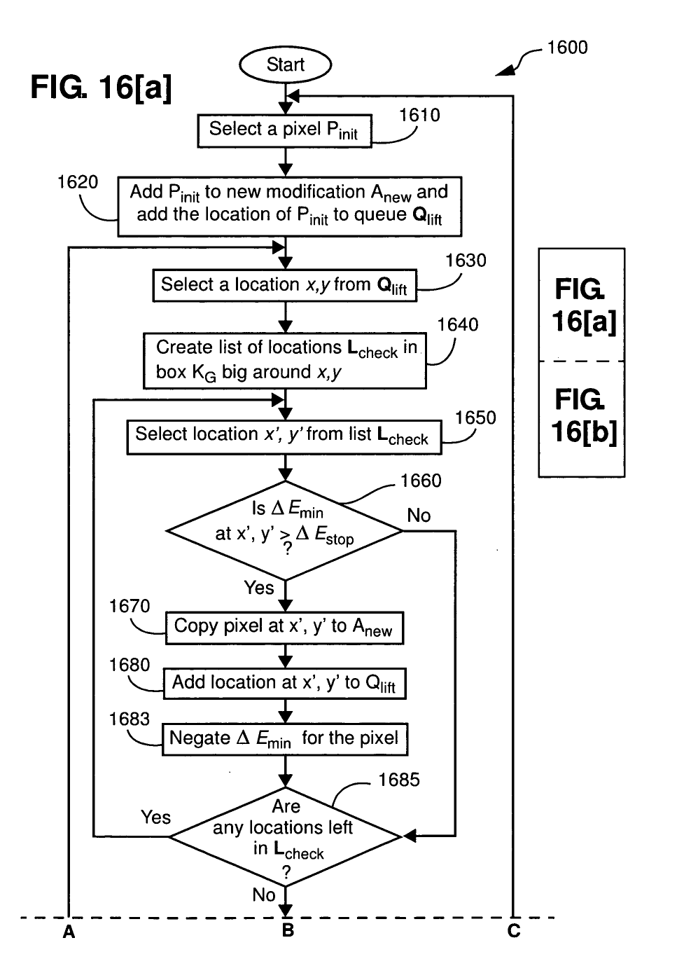

A triangulation map may be used to determine displacement as a triangulation map allows the determination of the displacement for any given pixel in a linear time relative to the number of vectors in the triangulation map. A Delaunay optimal triangulation may be used as a Delaunay optimal triangulation has the property of being smoother than other triangulation systems. The field of triangulation for a two-dimensional series of points P will now be described with reference to FIGS. 14(a), (b) and (c).

The triangulation described herein is based on generalised maps, or “G-Maps”. G-Maps are based on a combination of single topological elements known as darts. A dart 1410, as seen in FIG. 14 (a), in a triangulation G-Map is a unique triple d=(Vᵢ,Eⱼ,Tₖ) where Vᵢ is a vertex 1420, Eⱼ is an edge 1430, and Tₖ is a triangle 1440. For each triangle 1440, there are six possible combinations of vertex and edge, which may form a dart. For each edge surrounded by two triangles (e.g., 1440), there are four possible combinations of vertex and triangle, which may form a dart (e.g., 1410).

FIG. 14 (b) shows three functions for operating on darts α₀(d),α₁(d),α₂(d), where:
(i) α₀(d) may be used to determine a triple d′ which has the same edge and triangle, for a different vertex;
(ii) α₁(d) may be used to determine a triple d′ which has the same vertex and triangle, for a different edge; and
(iii) α₂(d) may be used to determine a triple d′ which has the same edge and vertex, for a different triangle.

For a dart d in a given triangulation topology, each of the above functions (i) to (iii) map to at most one triple d′, and each mapping is a bijection with the property αᵢ(αᵢ(d))=d. By combining the functions (i) to (iii) in a given order, every dart in a given triangulation may be visited. For this reason, these functions (i) to (iii) are also known as α-iterators. From the above definitions of the functions (i) to (iii), to navigate around the triangle containing a given dart, d₁, the other darts pointing in the same direction around the triangle are determined according to the following formulas (33) and (34):
d₂=α₁(α₀(d₁)) (33)
d₃=α₁(α₀(d₂)) (34)

The regions to the “left” of d and to the “right” of d may be defined. These are the regions to the left and right, respectively, of a vector formed using an initial point of Vᵢ along the line Eⱼ, in a plane where the triangle Tₖ always appears to the left of the vector.

A Delaunay triangulation Δ of a set of points, P, is the triangulation of P which maximises the minimum interior angles of the triangles, assuming that the boundary vectors of the triangulation are the convex hull of P. Maximising the minimum interior angle of each triangle is equivalent to ensuring that the circumcircle of each triangle does not enclose any points of P (known as the circumcircle test). The edges of such a triangle are known as “locally optimal”. A triangulation is Delaunay optimal if and only if all edges are locally optimal. In order to create an optimal triangulation from a non-optimal triangulation, a series of edges are swapped. For a given edge on the diagonal of a strictly convex quadrilateral (formed by two triangles of the triangulation), the edge is swapped if the circumcircle of one triangle encloses the fourth vertex of the quadrilateral. Swapping the edge involves moving the edge from one diagonal of the quadrilateral to the other. By applying such a method repetitively to a triangulation, the triangulation will converge to the optimal case in at most N iterations, where N represents the number of vertices in the triangulation.

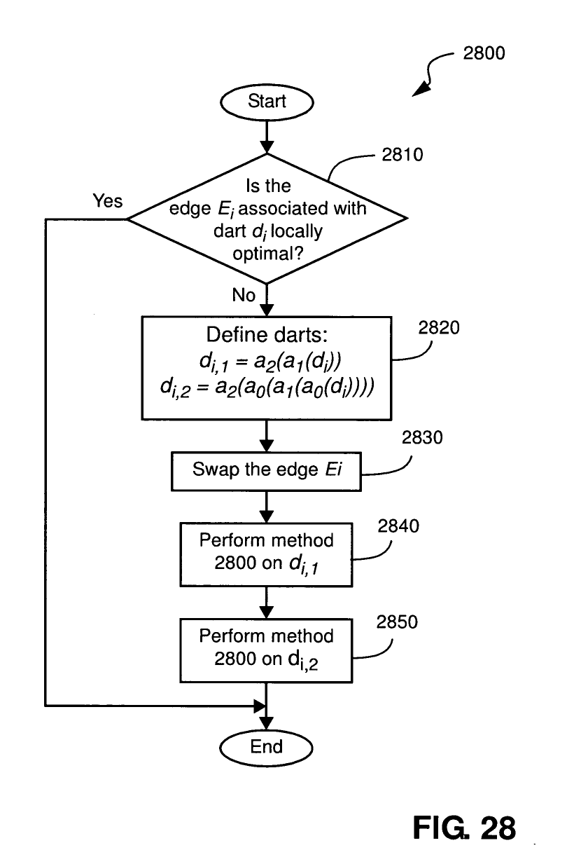

In order to build an optimised Delaunay triangulation A from a set of points P, an incremental algorithm may be used. To use the incremental triangulation algorithm, an initial triangulation is created, and each point from P is inserted, into A, with A being re-optimised after each insertion. The initial triangulation used is the triangulation generated by diagonally splitting a box, which encloses all the points of P. In one implementation, this box may be selected to be ten (10) times larger than the size of the image, in order that the border points are a long distance from all the points in P, meaning the influence from the border points is minimal. To add a node p from P to the triangulation Δ_{N}, which contains N nodes of P, the triangle Tᵢ in Δ_{N} that contains p is located and the triangle Tᵢ is split into three sub-triangles. The triangle Tᵢ is split into three sub-triangles by creating edges starting from the point p and extending to the three vertices of Tᵢ. A vertex swapping method 2800 (see FIG. 28) is then applied to the three sub-triangles. The method 2800 applies a circumcircle test to edges which are non-optimal until all edges are locally optimal, and thus the triangulation Δ_{N+1} is Delaunay optimal. Adding a node p from P to the triangulation Δ_{N}, will be further described below.

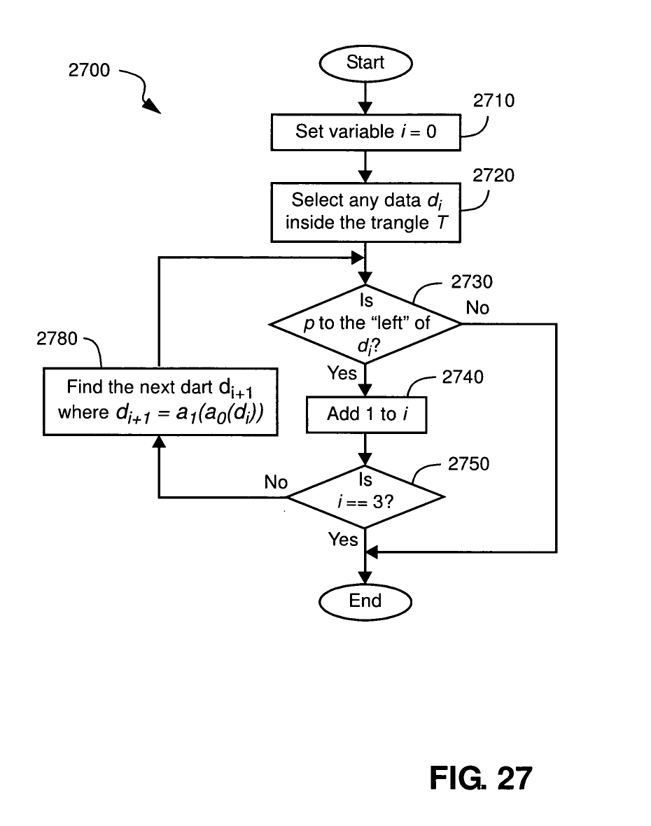

In order to locate the triangle Tᵢ in Δ_{N} in which a point p resides, each triangle in the triangulation is checked. A method 2700 of determining if a point p resides in a given triangle Tᵢ, will now be described with reference to FIG. 27. The method 2700 may be implemented as software resident on the hard disk drive 110 and being controlled in its execution by the processor 105.

The method 2700 begins at step 2710 by initialising a variable i to 0. At the next step 2720, an initial dart in the triangle Tᵢ is selected and assigned to the variable dᵢ. Any dart in the triangle Tᵢ may be selected at step 2720. At the next step 2730, if the processor 105 determines that p lies to the “left” (as defined above) of d_{i.} then the method 2700 proceeds to step 2740. Otherwise, if p does not lie to the left of dᵢ, then p does not lie within Tᵢ and the method 2700 concludes.

At step 2740, the variable i is incremented by one (1) and the method 2700 proceeds to step 2750. If the processor 105 determines that i is equal to three (3), at step 2750, then all three sides of the triangle Tᵢ have been considered in some direction, and p is to the “left” of all of the sides of the triangle Tᵢ. If p is to the “left” of all of the sides of the triangle Tᵢ then p lies within the triangle Tᵢ and the method 2700 concludes. If the processor 105 determines that i is not equal to three (3) at step 2750, then the method 2700 proceeds to step 2780, where the next dart to be examined is determined. The next dart to be examined may be determined using the following formula (35):
dᵢ₊₁=α₁(α₀(dᵢ)) (35)

Following step 2780, the method 2700 returns to step 2730 where p is checked against the next dart selected at step 2720. The method 2700 is applied to each triangle in the triangulation Δ_{N} until the triangle in which p resides (i.e., Tᵢ) is determined. The method 2700 may also be used to determine which triangle is to be used for interpolation at a given point, as will be described below.

The path followed around the triangle is also known as the 2-orbit of dᵢ. The method 2700 described above may also be used to determine which triangle should be used for interpolation, as will be described below.

Splitting the triangle Tᵢ into three sub-triangles by creating edges from p to the three vertices of Tᵢ creates three new edges using the points of Tᵢ, thus generating three new triangles. For example, as seen in FIG. 14(c), splitting the triangle Tᵢ into three sub-triangles produces three darts d₀, d₀′ and d₀″ appearing on the left side of one of the new edges, facing away from p for use in the vetex swapping method 2800. Any one of the darts d₀, d₀′ and d₀″ is acceptable for use in the swapping method 2800.

The vertex swapping method 2800 ensures that the triangulation Δ_{N} is optimal. The vertex swapping method 2800 recursively searches-and-swaps vertices starting from the three darts d₁, d₂ and d₃, as seen in FIG. 14 (c), representing the triples of the edges of the triangle Tᵢ (into which the point p has been inserted), the vertices of Tᵢ, and the three triangles surrounding Tᵢ, facing in a clockwise direction. The three darts d₁, d₂ and d₃ may be determined from d₀ described above using the following Equations (36), (37), and (38), where the brackets have been omitted from the α functions for clarity:
d₁=α₂α₁α₀α₁α₂α₁d₀ (36)
d₂=α₂α₁α₀α₁d₀ (37)
d₃=α₂α₁α₂α₀d₀ (38)

The darts d₁, d₂ and d₃ shown in FIG. 14(c) assume that the dart d₀ is used to determine the darts d₁, d₂ and d₃. However, the darts d₁, d₂ and d₃. may be determined using either of the other darts d₀′ and d₀″, which will swap the definitions of the darts d₁, d₂ and d₃.

The darts d₁, d₂ and d₃ are each used as input darts dᵢ to the vertex swapping method 2800. The vertex swapping method 2800 will now be described with reference to FIG. 28. The method 2800 begins at step 2810 where if the processor 105 determines that the edge Eᵢ associated with dart dᵢ is locally optimal using the circumcircle test, then the method 2800 is complete for dart dᵢ and the method 2800 concludes. If the edge Eᵢ is not locally optimal, at step 2810, then the method 2800 continues to step 2820 where two new darts are defined using the following formulas (39) and (40):
d_{i,1}=α₂α₁dᵢ (39)
d_{i,2}=α₂α₀α₁α₀dᵢ (40)

The method 2800 then proceeds to step 2830, where the edge Eᵢ is swapped to make the edge Eᵢ locally optimal. At the next step 2840, the processor 105 performs the method 2800 recursively on the new dart d_{i,1}. The method then proceeds to step 2850 where the processor 105 performs the method 2800 recursively on the new dart d_{i,2}. Following step 2850, the method 2800 concludes for the dart dᵢ.

Once an optimal Delaunay triangulation has been generated for the displacement map, D, the triangle which contains a given point may be found in linear time with respect to the number of points in the triangulation. The method 2700 may be used to decide which triangle contains a given point. The initially placed border points are given a displacement zero (0) and have been placed far from the centre of the displacement map, D, such that their effect on the interpolation of points within the rendered page image 311 but outside of the displacement map, D, points will be minimal.

Returning to the method 1300 of FIG. 13, at step 1340, the processor 105 determines the interpolated value for each position x,y in the image to determine an interpolated displacement map, D_{residual}. In step 1340, the triangle which contains the point x,y is located. Once vertices of the triangle n₀,n₁,n₂ are determined, the interpolation is performed using the formulae (41):

$${k}_{0} = \frac{( {n}_{1} x - x ) ( {n}_{2} y - y ) - ( {n}_{2} x - x ) ( {n}_{1} y - y )}{( {n}_{1} x - {n}_{0} x ) ( {n}_{2} y - {n}_{0} y ) - ( {n}_{2} x - {n}_{0} x ) ( {n}_{1} y - {n}_{0} y )} \\ {k}_{1} = \frac{( {n}_{2} x - x ) ( {n}_{0} y - y ) - ( {n}_{0} x - x ) ( {n}_{2} y - y )}{( {n}_{1} x - {n}_{0} x ) ( {n}_{2} y - {n}_{0} y ) - ( {n}_{2} x - {n}_{0} x ) ( {n}_{1} y - {n}_{0} y )} \\ {k}_{2} = \frac{( {n}_{0} x - x ) ( {n}_{1} y - y ) - ( {n}_{1} x - x ) ( {n}_{0} y - y )}{( {n}_{1} x - {n}_{0} x ) ( {n}_{2} y - {n}_{0} y ) - ( {n}_{2} x - {n}_{0} x ) ( {n}_{1} y - {n}_{0} y )} \\ {D}_{residual} ( x , y ) = {k}_{0} \times {D}_{0} + {k}_{1} \times {D}_{1} + {k}_{2} \times {D}_{2} \qquad ( 41 )$$

where nᵢx and nᵢy are the x and y coordinates of vertex nᵢ, respectively. Dᵢ represents the displacement measured at vertex nᵢ.

The method 1300 concludes at the next step 1350, where the processor 105 reapplies the removed best fit linear transformation to the interpolated displacement map D_{residual} to form a distortion map D_{fine}(x,y), using the following formula (42):

$${D}_{fine} ( x , y ) \to {D}_{residual} ( x , y ) + ( \begin{matrix}{b}_{11} & {b}_{21} \\ {b}_{12} & {b}_{22}\end{matrix} ) ( \begin{matrix}x \\ y\end{matrix} ) + ( \begin{matrix}Δ x \\ Δ y\end{matrix} ) \qquad ( 42 )$$

The map D_{fine}(x,y) forms the distortion map that relates each pixel in the coarsely registered scanned page image 312 to a pixel in the coordinate space of the corresponding rendered page image 311, as determined as at step 605 of the method 600.

Returning to the method 1000, at the next step 1007, the processor 105 accesses the scanned page image 312, which has not been coarsely registered, from the scanned page images 320. The processor 105 uses the parameters generated by the coarse registration process and the distortion map D_{fine}(x,y), and outputs a finely registered page image to a set of finely registered page images 340, as seen in FIG. 3. Each of the pages (e.g., 313) of the finely registered page images 340 are registered to corresponding rendered page images (e.g., 311) from the rendered pages images 310.

At step 1007, the processor 105 modifies the distortion map D_{fine}(x,y) so that the distortion map D_{fine}(x,y) forms a displacement map relating pixels in the rendered page images 310 to pixels in the scanned page images 320. The processor 105 adds the linear translation parameters determined above during coarse registration into the distortion map D_{fine}(x,y) according to the following formula (43):

$${D}_{warp} ( x , y ) \to {D}_{fine} ( x , y ) + ( \begin{matrix}{a}_{11} & {a}_{21} \\ {a}_{12} & {a}_{22}\end{matrix} ) ( \begin{matrix}x \\ y\end{matrix} ) + ( \begin{matrix}{x}_{0} \\ {y}_{0}\end{matrix} ) \qquad ( 43 )$$

Pixels in a particular scanned page image 312 corresponding to pixels in a corresponding rendered page image 311 may be found by using the displacement map D to determine the sub-pixel location on the scanned page image 312 that corresponds to the point in the rendered page image 311, and interpolating the colour value in the scanned page image 312 at that location. Such interpolation may be bicubic.

To execute step 1007, an empty image the size of the particular rendered page image (e.g., 311) is generated in memory 106 or the hard disk drive 110. For each pixel in the empty image, an (x,y) coordinate is taken from the corresponding pixel in warp map D_{warp}(x,y). This (x,y) coordinate may be used to determine, by interpolation, a value from the scanned page image 312 corresponding to the rendered page image 311. The interpolated value, and hence the warped image, contains several components, in particular red, green, blue (RGB) intensity components. This interpolated value may be stored in the created image to form the finely registered page images 340.

Returning to the method 200, following the formation of the finely registered page images 340, in step 250 of the method 200, at the next step 260 the processor 105 aligns colours of the finely registered page images 340 with those of the rendered page images 310.

The colours of the document 300 may be altered considerably through printing and scanning of the document 300. In order to extract only significant differences between two images, the colours of the two images may be aligned.

Colour alignment is performed at step 260 by comparing the registered page images 340 with the rendered page images 310 and determining how the different colour components change between the images. In performing colour alignment, the colour of the registered page images 340 is considered to change in a predictable way according to a particular model. The colour alignment determines the parameters of the model to minimise predicted error. As described herein, the colour of the registered page images 340 is considered to undergo an affine transform (i.e., 1^{st} order polynomial model). However, other models may be used. For example, a gamma correction model or an n-th order polynomial model may be used to perform the colour alignment at step 260.

If the colour of a pixel of a rendered page image (e.g., 311) has undergone an affine transform through scanning or printing, the colour of the pixel has been transformed according to the following formula (44):

$$[ \begin{matrix}{P}_{predicted}^{1} \\ {P}_{predicted}^{2} \\ {P}_{predicted}^{3}\end{matrix} ] = [ \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ] [ \begin{matrix}{P}_{original}^{1} \\ {P}_{original}^{2} \\ {P}_{original}^{3}\end{matrix} ] + [ \begin{matrix}{C}_{1} \\ {C}_{2} \\ {C}_{3}\end{matrix} ] \\ = A [ \begin{matrix}{P}_{original}^{1} \\ {P}_{original}^{2} \\ {P}_{original}^{3}\end{matrix} ] + C \qquad ( 44 )$$

where P_{predicted}ⁱ represent the expected original colour components according to the affine transformation model, and P_{original}ⁱ represents the colour components of the rendered image. The colour components P¹,P²,P³ refer to red, green and blue (RGB) components, respectively.

At step 260, the processor 105 determines the matrices A,C such that error in the predicted colour is minimised. The error may be determined according to the following formula (45):
e²=Σ(P_{predicted}¹−P_{original}¹)²+(P_{predicted}²−P_{original}²)²+(P_{predicted}³−P_{original}³)² (45)
where the summation sums over all pixels in a finely registered page image (e.g., (1213) from the registered page images 340 and P_{predicted}ⁱ represents the colour components of the pixel from the finely registered page image 313 being summed.

To find the parameters of each element of A,C so that e² is minimized, the derivative of e² with respect to the element of A,C is required to be equal to zero (0), as follows:

$$\frac{\partial {e}^{2}}{\partial p} = 0 \\ \begin{matrix}\frac{\partial {e}^{2}}{\partial p} = \sum 2 ( {P}_{predicted}^{1} - {P}_{original}^{1} ) \frac{\partial {P}_{predicted}^{1}}{\partial p} + \\ \sum 2 ( {P}_{predicted}^{2} - {P}_{original}^{2} ) \frac{\partial {P}_{predicted}^{2}}{\partial p} + \\ \sum 2 ( {P}_{predicted}^{3} - {P}_{original}^{3} ) \frac{\partial {P}_{predicted}^{3}}{\partial p} \\ = 0\end{matrix} \qquad ( 46 )$$

where p is a parameter of the model used. In the case of affine transform, the parameters used are the Aᵢⱼ and Cᵢ. Equation (46) may be rearranged to give the following equation:

$$\sum {P}_{predicted}^{1} \frac{\partial {P}_{predicted}^{1}}{\partial p} + \sum {P}_{predicted}^{1} \frac{\partial {P}_{predicted}^{2}}{\partial p} + \sum {P}_{predicted}^{2} \frac{\partial {P}_{predicted}^{3}}{\partial p} = \sum {P}_{unwarped}^{1} \frac{\partial {P}_{unwarped}^{1}}{\partial p} + \sum {P}_{unwarped}^{2} \frac{\partial {P}_{unwarped}^{2}}{\partial p} + \sum {P}_{unwarped}^{3} \frac{\partial {P}_{unwarped}^{3}}{\partial p} \qquad ( 47 )$$

For an affine colour transform,

$$\begin{matrix}\frac{\partial {P}_{predicted}^{k}}{\partial {A}_{ij}} = \{ \begin{matrix}{P}_{original}^{j} if ( k = i ) \\ 0 f ( k \neq i )\end{matrix} \\ & ( 48 ) \\ \frac{\partial {P}_{predicted}^{k}}{\partial {C}_{i}} = \{ \begin{matrix}1 if ( k = i ) \\ 0 f ( k \neq i )\end{matrix} & ( 49 )\end{matrix}$$

If two new matrices, M,L are defined according to the following formulas (50) (51), where all summations are assumed to be over all pixels:

$$\begin{matrix}M = [ \begin{matrix}\sum 1 & \sum {P}_{original}^{1} & \sum {P}_{original}^{2} & \sum {P}_{original}^{3} \\ \sum {P}_{original}^{1} & \sum {P}_{original}^{1} {P}_{original}^{1} & \sum {P}_{original}^{1} {P}_{original}^{2} & \sum {P}_{original}^{1} {P}_{original}^{3} \\ \sum {P}_{original}^{2} & \sum {P}_{original}^{2} {P}_{original}^{1} & \sum {P}_{original}^{2} {P}_{original}^{2} & \sum {P}_{original}^{2} {P}_{original}^{3} \\ \sum {P}_{original}^{3} & \sum {P}_{original}^{3} {P}_{original}^{1} & \sum {P}_{original}^{3} {P}_{original}^{2} & \sum {B}_{original} {P}_{original}^{3}\end{matrix} ] & ( 50 ) \\ L = [ \begin{matrix}\sum {P}_{unwarped}^{1} & \sum {P}_{unwarped}^{2} & \sum {P}_{unwarped}^{3} \\ \sum {P}_{unwarped}^{1} {P}_{original}^{1} & \sum {P}_{unwarped}^{2} {P}_{original}^{1} & \sum {P}_{unwarped}^{3} {P}_{original}^{1} \\ \sum {P}_{unwarped}^{1} {P}_{original}^{2} & \sum {P}_{unwarped}^{2} {P}_{original}^{2} & \sum {P}_{unwarped}^{3} {P}_{original}^{2} \\ \sum {P}_{unwarped}^{1} {P}_{original}^{3} & \sum {P}_{unwarped}^{2} {P}_{original}^{3} & \sum {P}_{unwarped}^{3} {P}_{original}^{3}\end{matrix} ] & ( 51 )\end{matrix}$$

The following formula (52) may be used to find values for A,C which minimise the error e²:

$$[ \begin{matrix}{C}^{T} \\ {A}^{T}\end{matrix} ] = [ \begin{matrix}{C}_{1} & {C}_{2} & {C}_{3} \\ {A}_{11} & {A}_{21} & {A}_{31} \\ {A}_{12} & {A}_{22} & {A}_{32} \\ {A}_{13} & {A}_{23} & {A}_{33}\end{matrix} ] = {M}^{- 1} L \qquad ( 52 )$$

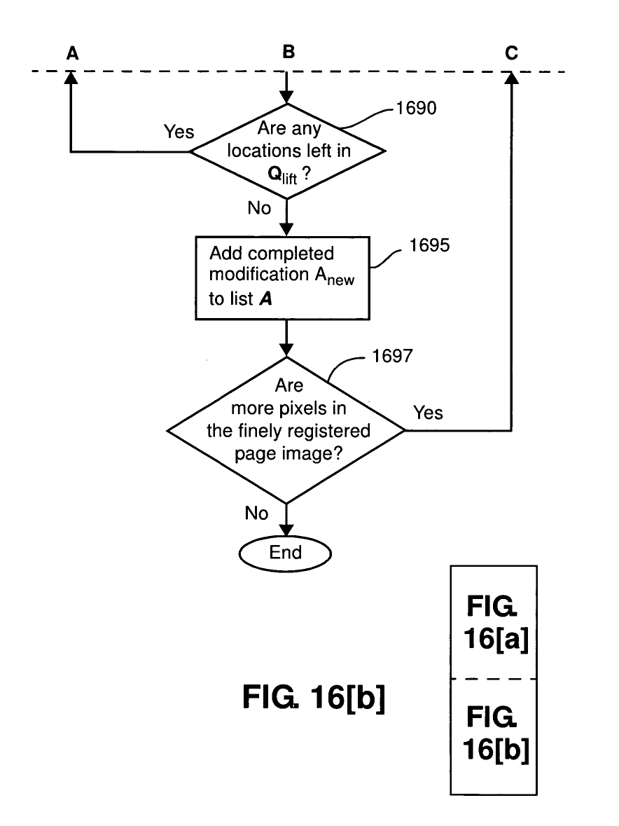

A method 1500 of aligning colours of the finely registered page images 340 with the rendered page images 310, as executed at step 260, will now be described with reference to FIG. 15. The method 1500 may be implemented as software resident on the hard disk drive 110 and being controlled in its execution by the processor 105.

The method 1500 begins at step 1510, where the processor 105 accesses a finely registered page image (e.g., 313) and a corresponding rendered page image (e.g., 311). At the next step 1520, the processor 105 initialises four structures, configured within memory 106, to contain zeros (the structures are 0-indexed). The first of these structures is a 4×3 matrix, L. The second structure is a 4×4 matrix, M. The third structure is a four element vector, R and the fourth structure is a three element vector, O. At the next step 1530, for each unprocessed pixel P_{original}ⁱ from the rendered page image 313, a corresponding unprocessed pixel, P_{registered}ⁱ, is selected from the finely registered page image 313. The unprocessed pixels P_{original}ⁱ may be selected for processing in x,y order and the corresponding unprocessed pixels P_{registered}ⁱ may be selected by choosing a pixel that is most similar to P_{original}ⁱ and which is also inside a five (5) pixel by five (5) pixel box centred at the same position as P_{original}ⁱ. Similarity is measured in this regard using the following formula (53):
si=−((P_{original}¹−P_{registered}¹)²+(P_{original}²−P_{registered}²)²+(P_{original}³−P_{registered}³)²) (53)
Formula (53) results in si=0 if two pixels are identical. The more dissimilar the two pixels are, the lower the si value.

The method 1500 continues at the next step 1540, where the red, blue and green (RGB) colour components of the unprocessed pixel P_{registered}ⁱ are stored in the four element vector, R, configured within memory 106. The red, blue and green colour components are stored at R[1], R[2], and R[3], respectively, where R[0] is set to one (1).

The method 1500 continues at the next step 1550, where the red, green and blue (RGB) colours components of the unprocessed pixel P_{original}ⁱ are stored in the three element vector O, configured in memory 106. The red, green and blue colour components (RGB) of the unprocessed pixel P_{original}ⁱ are stored at O[0], O[1], and O[2], respectively.

The method 1500 continues at the next step 1560, where each element of the matrix, M, is modified using the following formula (54):
M[j,k]=M[j,k]+R[j]R[k] (for j=0 . . . 3,k=0 . . . 3) (54)

Then at the next step 1570, each element of the matrix, L, is modified using the following formula (55):
L[j,k]=L[j,k]+R[h]O[k] (for j=0 . . . 3,k=0 . . . 2) (55)

The method 1500 continues at the next step 1580, where if the processor 105 determines that there are any unprocessed pixels left in the registered page image 313, then the method 1500 returns to step 1530. Otherwise, if all pixels of the registered page image 313 have been processed, then the method 1500 proceeds to step 1590. At step 1590, the processor 105 determines the matrices A and C using formula (52). The matrices A and C may be stored in memory 106 or the hard disk drive 110.

Once the matrices A, C have been determined, colour alignment may be performed. Formula (44) is applied to each pixel in the rendered page image 312 from the set of rendered page images 310 to form a colour aligned rendered page image. The method 1500 may be repeated for each pair corresponding pair of images (e.g., 311 and 313) from the rendered page images 310 and the finely registered page images 340.

Following the colour alignment in accordance with the method 1500 at step 260, the method 200 proceeds to step 270, where a list of modifications A is generated in memory 106 or the hard disk drive 110. The list of modifications A may be used to generate modified pages 350, as seen in FIG. 3. For each pixel in a finely registered page image (e.g., 313) of the finely registered page images 340, a minimum required change in energy of the pixel (ΔEₘᵢₙ) from the colour aligned rendered page image is determined based on changes in the neighbouring pixels. For example, for two pixels P₁ and P₂, at locations x₁, y₁ and x₂, y₂ respectively, having colour values in the red, green and blue (RGB) colour space between −1 and 1 of R₁, G₁, and B₁ for pixel P₁, and R₂, G₂, and B₂ for pixel P₂. The difference in energy between the two pixels, P₁ and P₂, ΔE is defined according to the following formula (56):
ΔE(P₁,P₂)=(R₁−R₂)²+(G₁−G₂)²+(B₁−B₂)² (56)

The value of ΔEₘᵢₙ for a pixel at location x,y may be determined by finding the minimum ΔE value for the region using the following formula (57):

$$Δ {E}_{min} ( {P}_{f} [ x , y ] ) = {min}_{{x}^{'} = x \to {K}_{B} … x + {K}_{B} \\ {y}^{'} = y - {K}_{B } … y + {K}_{B}} ( Δ E ( {P}_{f} [ {P}_{f} [ x , y ] , {P}_{c} [ x ' , y ' ] ) ) \qquad ( 57 )$$

where P_{f}[x,y] represents a pixel from the finely registered image (e.g., 313) at location x,y, P_{c}[x′,y′] represents a pixel from a corresponding colour aligned rendered page image (e.g., 311) at location x′,y′, and KB represents box size. KB may be set to two (2), for example. The value of ΔEₘᵢₙ is determined for the entire finely registered image 313 (i.e., all valid combinations of x,y and x′,y′). Once the value of ΔEₘᵢₙ is determined for the entire finely registered image 313, the value determined for each pixel is compared to a threshold ΔE_{lift}, (e.g., ΔE_{lift} may be selected to be 0.4) starting from a top left pixel of the finely registered page image 313. If the value of ΔEₘᵢₙ for a given x,y location exceeds ΔE_{lift}, a modification is added to the list of modifications A, configured within memory 206, for the pixel at that given location.

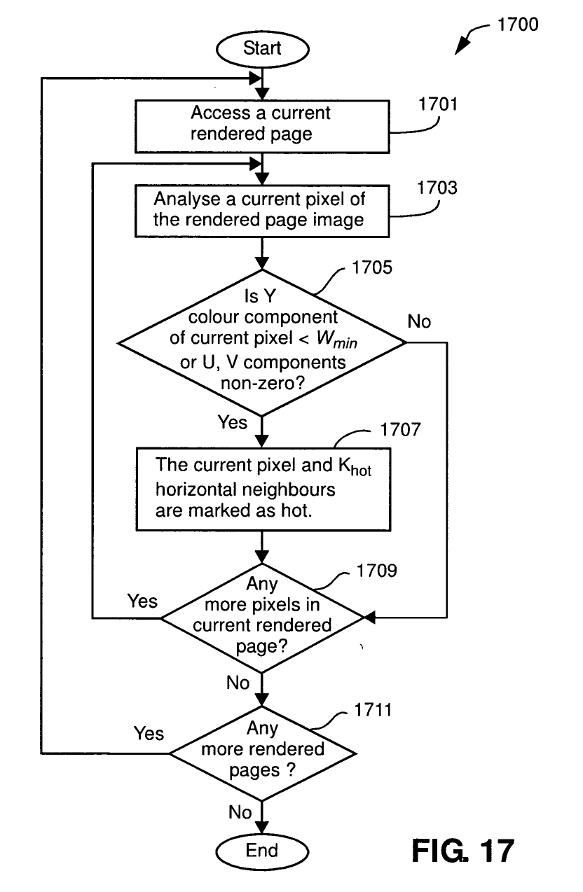

A method 1600 of generating a list of modifications A, as executed step 270, will now be described with reference to FIG. 16. The method 1600 may be implemented as software resident on the hard disk drive 110 and being controlled in its execution by the processor 105.

The method 1600 generates modifications A_{new} which can be added to the list of modifications, A. The list of modifications A is initially empty. Each modification in the list comprises a group of pixels, which have been extracted from a given pixel location in the finely registered page image 313, as well as further data which will be described below.

The method 1600 begins at step 1610, where the processor 105 selects a pixel Pᵢₙᵢₜ from a finely registered page image (e.g, 313). At the next step 1620, a new modification A_{new} is configured in memory 106, and the pixel Pᵢₙᵢₜ is added to the new modification A_{new}. Also at step 1620, a breadth-first-search is started by adding the x,y location of the pixel Pᵢₙᵢₜ to the end of a queue of search points Q_{lift} configured within memory 106. The search begins by selecting a location from the queue Q_{lift} queue (x,y) at step 1630. At the next step 1640, the location selected at step 1630 with coordinates x′,y′ is added to a list of locations if x−K_{G}<x′<x+K_{G} and y−K_{G}<y′<y+K_{G}, to check for lifting, L_{check}. K_{G} may be set to the same value as K_{B} (i.e., two (2)). However, the value of K_{G} and the value of K_{B} do not have to be the same. At the next step 1650, a location is selected from L_{check}. Then at the next step 1660, the pixel at the location selected at step 1650 is analysed to determine if the value of ΔEₘᵢₙ for that selected pixel exceeds a minimum threshold ΔEₛₜₒₚ (e.g., 0.016). If the value of ΔEₘᵢₙ for the pixel selected at step 1660 exceeds a minimum threshold ΔEₛₜₒₚ, then the method 1600 proceeds to step 1670 where the pixel is copied to the new modification A_{new}, and the location of the pixel is added to the end of the queue of search points Q_{lift} at the next step 1680. If the value of ΔEₘᵢₙ for the pixel selected at step 1660 is less than or equal to the minimum threshold ΔEₛₜₒₚ, at step 1660, then the method 1600 proceeds to step 1685. At the next step 1683, the value of ΔEₘᵢₙ for the pixel selected at step 1670 is negated, such that the pixel is not matched in future searches of the location corresponding to the pixel.

If there are more locations left in L_{check} at step 1685, the method 1600 returns to step 1650. Otherwise, the method 1600 proceeds to step 1690. At step 1690, if there are any locations left in Q_{lift}, the method 1600 returns to step 1630 and another location is taken from the queue for searching.

When there are no pixels left to search in the queue of search points Q_{lift}, the bounding box of the modification A_{new} is recorded in memory 106 as a bitmap and the modification A_{new} is added to the modification list A at step 1695 of the method 1600. The bounding box represents the minimum x′ and y′ values and maximum x′ and y′ values for the pixel locations, which have been determined in step 1660 to produce the modification A_{new}. These values are collected during the execution of the method 1600. At the next step 1697, if there are any more unprocessed pixels in the finely registered page image 313, the method 1600 returns to step 1610. Otherwise, the method 1600 concludes. When there are no points left in the image with a ΔEₘᵢₙ greater than ΔE_{lift}, the modification list A is complete.

FIG. 3 shows modified pages 350 comprising modifications (e.g., 317) that are included in the modification list A. The modifications of the list A may contain some noise due to misregistration and other small differences between the rendered page image 311 and the finely registered page image 313.

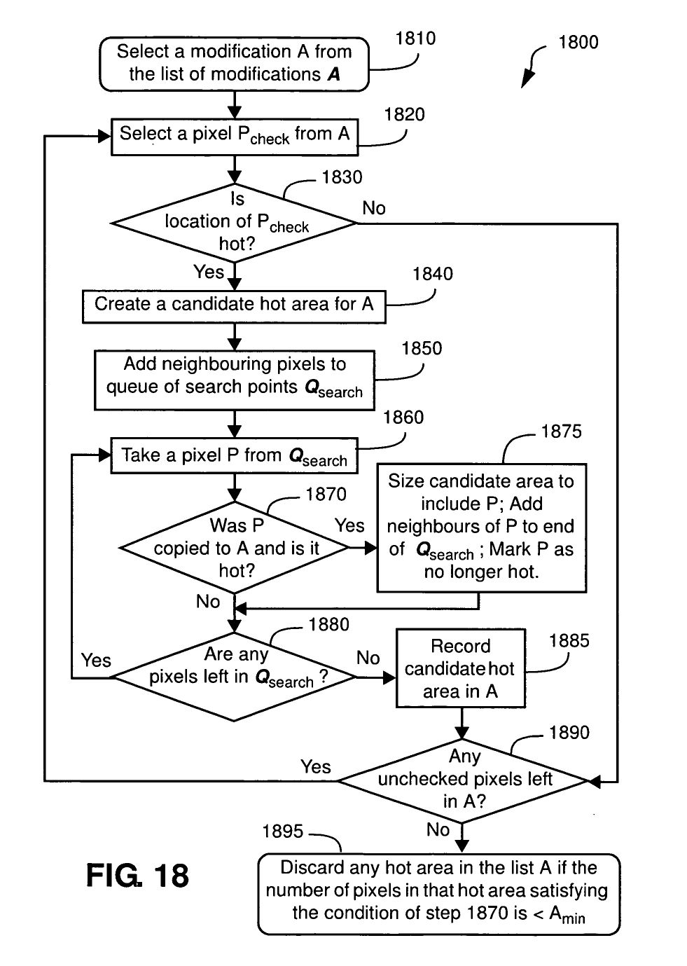

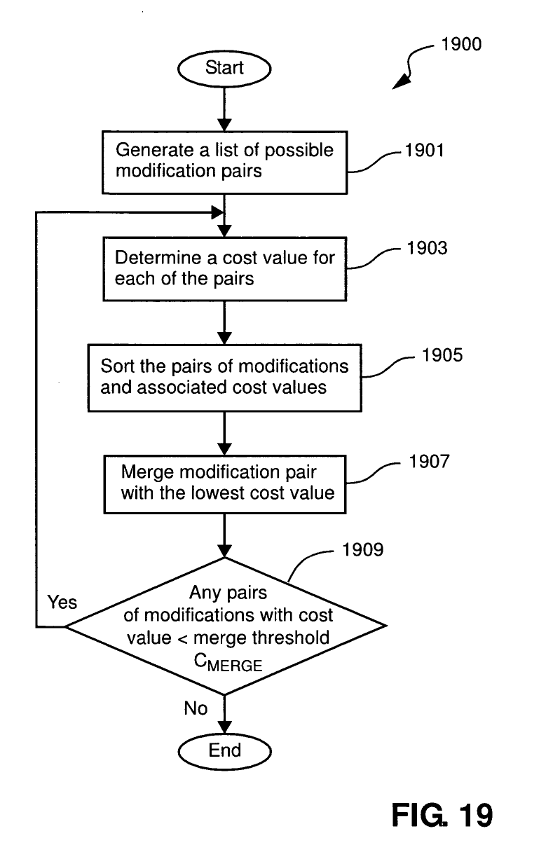

Once the modification list A is complete, the method 200 proceeds to a merging step 290 to logically merge physically separated modifications and remove any insignificant modifications from the list A. The merging step 290 includes four sub-steps. At the first sub-step 205, hotspot images 330, as seen in FIG. 3, are generated by the processor 105. The hotspot images 330 are bi-level images representing areas of a page that already have text or graphics present on them (i.e., “hot” areas). A method 1700 of generating hotspot images 330, as executed at step 205, will be described in detail below with reference to FIG. 17. The method 200 continues at the next step 215, where the processor 105 detects hot modifications. A method 1800 of detecting hot modifications, as executed at step 215, will be described in detail below with reference to FIG. 18.

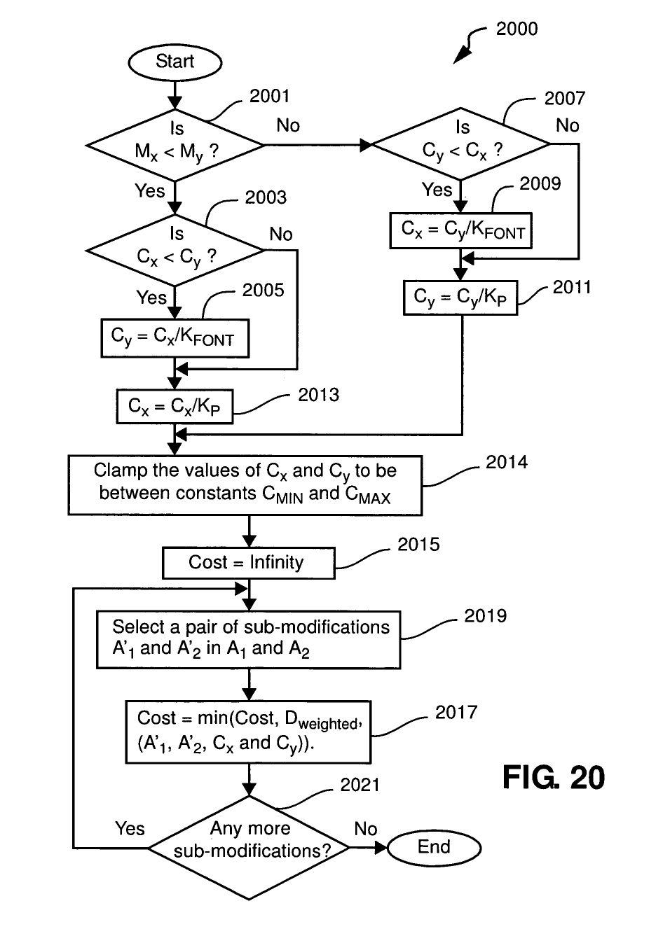

The modifications are then merged, using the hotspot images 330, at the next step 225 of the method 200. A method 1900 of merging modifications, as executed at step 225, will be described below with reference to FIG. 19. The method 200 concludes at the next step 235, where a final list of merged modifications is generated by the processor 105. Steps 205, 215, 225 and 235 will now be described in detail.

As described above, the hotspot images 330 are bi-level images representing areas of a page that already have text or graphics present on them (i.e., “hot” areas). A value of one (1) may be used to represent a hot area on a page (e.g., 301) of the document 300. Further, a value of zero (0) may be used to represent a non-hot area on the page 301 of the document 300. A modification to the page 301 of the document 300 may be considered hot if the modification intersects one or more of the generated hot areas of the page 301 to a significant degree. The amount that a modification intersects a hot area is referred to herein as “hotness”. The hotness of a modification or how much the modification intersects with the hot area enable text to which a modification refers to be identified.

The method 1700 for generating the hotspot images 330, as executed at step 205, will now be described in detail with reference to FIG. 17. The method 1700 may be implemented as software resident on the hard disk drive 106 and being controlled in its execution by the processor 105.

The method 1700 begins at step 1701, where one of the rendered page images (e.g., 311) is accessed from memory 106 or the hard disk drive 110 by the processor 105 and becomes a current rendered page image for the purpose of the description. At the next step 1703, the processor 105 analyses a first pixel (i.e., the current pixel) of the current rendered page image 311. Then at step 1705, if a Y colour component of the YUV colour value for the current pixel is less than a predetermined white threshold, Wₘᵢₙ, or the U or V colour components are non-zero then the current pixel and Kₕₒₜ of the horizontal neighbours of the pixel (i.e., neighbouring pixels evenly distributed to the left and right) are marked as hot, at the next step 1707. Otherwise, the method 1700 proceeds directly to step 1709. Information marking the hot pixels of the current rendered page image 311 is stored in memory 106 or the hard disk drive 110, as a hot spot image (e.g., 314) for the current rendered page image 311. In one implementation, Wₘᵢₙ may be set to a value of 0.8 of a maximum possible Y value, and Kₕₒₜ may be selected to be equal to sixteen (16). At step 1709, if there are any more pixels left to be processed in the current rendered page image 311, then the method 1700 returns to step 1701 to process a next pixel of the current rendered page image 311. Otherwise, the method 1700 proceeds to step 1711, where if there are any more rendered page images 310 to be processed then the method 1700 returns to step 1701. Otherwise, the method 1700 concludes.

The generation of the hotspot images 330 in accordance with the method 1700 requires only the rendered page images 310 and is independent of the registration and colour matching described above. As such, the generation of the hotspot images 330 may be performed before registration and colour matching, so that the page images (e.g., 301, 302, 303 etc) only need to be loaded once, and may then be subsequently modified.

The method 1800 of detecting hot modifications will now be described in detail with reference to FIG. 18. The method 1800 may be implemented as software resident on the hard disk drive 110 and being controlled in its execution by the processor 105. In the method 1800 the processor 105 iterates through each modification in the list of modifications A. For each modification of the list of modifications A, hot areas are determined.

The method 1800 begins at the first step 1810, where the processor 105 selects a modification A from the list of modifications A. At the next step 1820, an unprocessed pixel P_{check} is selected from the selected modification A. The modification A and the pixel P_{check} correspond to a particular hot spot image (e.g., 314) of the hot spot images 330. At the next step 1830, if the processor 105 determines that the pixel P_{check} is marked hot in the corresponding hot spot image 314, then the method 1800 proceeds to step 1840. At step 1840, the processor 105 creates a new candidate hot area for the modification A. Then at the next step 1850, the neighboring pixels of the pixel P_{check} (in the horizontal and vertical directions) are added to a queue Q_{search} of search points.

The method 1800 continues at the next step 1860, where the processor 105 selects a pixel P from the queue Q_{search} of search points. Then at step 1870, if the pixel selected at step 1860, was copied to the modification A and was marked as hot in the corresponding hot spot image 314, then the method 1800 proceeds to step 1875. Otherwise, the method 1800 proceeds to step 1880. At step 1875, the candidate hot area is expanded to include the pixel P and the neighboring pixels of the pixel P are added to the queue Q_{search} of search points. Also at step 1875, the processor 105 marks the pixel P as no longer being hot. Then at the next step 1880, if the processor 105 determines that there are more pixels left in the queue Q_{search}, then the method 1800 returns to step 1860 where another pixel is examined. Otherwise, the method 1800 proceeds to step 1885, where the hot area is stored in memory 106 together with the modification A in a list of candidate hot areas configured within memory 106.

The method 1800 continues at the next step 1890, if there are any unprocessed pixels left in the modification A, then the method 1800 returns to step 1820. Otherwise, the list of candidate areas is complete and the method 1800 proceeds to step 1895. At step 1895, for each candidate hot area in the list of candidate hot areas, the number of pixels of that hot area which satisfied the conditions of step 1870 is compared to a threshold, Aₘᵢₙ. If the number of pixels of that hot area that satisfied the conditions of step 1870 is less than Aₘᵢₙ, then that hot area is discarded. Step 1895 may alternatively be performed at step 1885 before the candidate hot area is added to the list of candidate hot areas. Comparing the number of pixels of a particular hot area that satisfy the conditions of step 1870 to a threshold, Aₘᵢₙ reduces the effect of noise and requires a significant overlap of a modification and text or diagrams for a modification to become hot. If the number of pixels is more than Aₘᵢₙ, the hot area is kept in the list of candidate hot areas. Aₘᵢₙ may be set to one hundred and fifty (150). As such a bounding box for a candidate hot area is determined for each location where a modification overlaps hot pixels in the corresponding hot spot image 314. Once all of the candidate hot areas have been determined for a particular modification, the candidate hot area with the largest total area enclosed by a bounding box is selected to be the hot area for the modification, and the modification is marked as hot. If no candidate hot areas remain in the list of candidate hot areas, then the modification is marked as not being hot.

Once the hotness of the modifications of the list of modifications A has been determined at step 215 of the method 200, the modifications are merged together at the next step 225 of the method 200 using a clustering algorithm. The modifications may be merged by determining the cost value of a cost function for each of a plurality of pairs of modifications, and merging the modification pairs having a cost value less than a predetermined threshold value.

A method 1900 of merging modifications as executed at step 225 will now be described in detail with reference to FIG. 19. The method 1900 may be implemented as software resident on the hard disk drive 110 and being controlled in its execution by the processor 105.

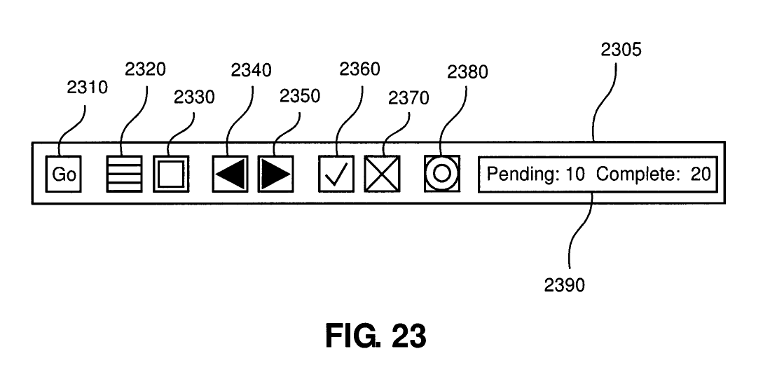

The method 1900 begins at step 1901, where the processor 105 generates a list of modification pairs within memory 106 or the hard disk drive 110. The list of modification pairs contains all possible pairs of modifications. At the next step 1903, for each pair of modifications in the list of modification pairs, the processor 105 determines a cost value representing the cost to merge the modifications in the pair. A method 2300 of determining the cost value for merging two modifications (i.e., a pair of modifications), as executed at step 1903, will be described below with reference to FIG. 23.

The method 1900 continues at the next step 1905, where the processor 105 sorts the list of modification pairs such that the modification pair with the lowest cost to merge may be merged first. At the next step 1907, the modification pair with the lowest associated cost value is merged. Once a pair of modifications has been merged, the pair becomes a single modification with two sub-modifications. As a result, the cost to merge additional modifications may change, since a modification has an overall bounding box, and also may contain any number of sub-modifications with their own bounding boxes. The bounding box of a modification containing sub-modifications is the smallest rectangle that is able to contain all the sub-modification bounding boxes. Thus, every time a modification pair is merged, the cost to connect that pair of modifications to the rest of the modifications is re-determined, as the overall modification has changed. Accordingly, at the next step 1909, if the processor 105 determines that there are any pairs of modifications with an associated cost value that is lower than a predetermined merge threshold C_{MERGE} (e.g., C_{MERGE}=2), then the method 1900 returns to step 1903. Otherwise, the method 1900 concludes. The method 1900 is repeated for each of the pairs of modifications including the newly merged pair of modifications.

The method 1900 is performed on a per-page (e.g., per hot spot image 314 and per corresponding modified page image 352) basis. The cost of merging modifications (e.g., from different modified pages 350 is implicitly infinite, and will not be considered. However, in one implementation, the cost of merging modifications from different modified pages 350 may be determined. The cost of merging modifications (e.g., 331 and 333) is determined based on hotness, the shape of the modifications, and the minimum distance between the bounding boxes of the sub-modifications. The merging method 1900 may be executed twice. In the first execution of the method 1900, non-hot modifications may be considered and merged. In the second execution of the method 1900, both hot and non-hot modifications may be considered and merged. Executing the method 1900 twice, allows non-hot modifications to be merged so that cost determinations are based purely on shape and location of modifications. In the second execution of the method 1900, at most one non-hot modification may be merged to each hot modification, and two hot modifications are not merged. Since the lowest cost merges are performed first, a hot modification will be merged to its lowest cost neighbour and no others.

For merging two non-hot modifications, the determination of the cost of merging modifications is based on the distance between the two nearest sub-modifications of the two modifications, where the contribution of the x and y directions are scaled depending on the shape of the existing sub-modifications. The scaling is used to favour merging modifications with the same orientation and thus favour merging words of written text. For example, if a modification is currently much wider than the modification is high, the modification is assumed to be writing in a horizontal direction. As a result, the cost to merge that modification with another modification in a horizontal direction is lower than the cost to merge the modification with another modification the same distance above or below. In one implementation, two hot modifications are not merged, so the cost of merging two modifications involving at least one hot sub-modifications is defined to be some value larger than the merge threshold, C_{MERGE}, as will be described in detail below.

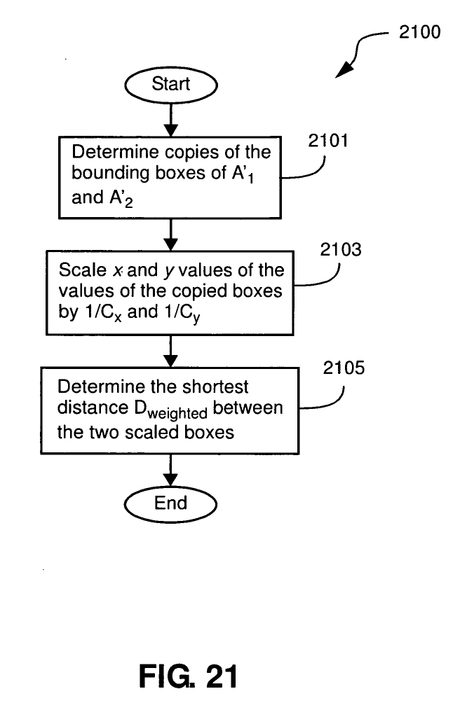

The method 2000 of determining the cost value for merging two modifications A₁ and A₂ (assumed to be different and non-hot), as executed at step 1903, will be described below with reference to FIG. 20. The method 2000 begins at the first step 2001, where if the processor 105 determines that the larger width Mₓ of the bounding boxes of modifications A₁ and A₂ is less than the larger height M_{y} of the bounding boxes of A₁ and A₂ (i.e., if Mₓ<M_{y}), then the method 2000 proceeds to step 2003. Otherwise, the method 2000 proceeds to step 2007. At the next step 2003, if the largest width Cₓ of any sub-modification from A₁ or A₂ is less than the largest height C_{y} of any sub-modification from A₁ or A₂, then the method 2000 proceeds to step 2005. Otherwise the method 2000 proceeds to step 2013. At step 2005, the processor 105 sets C_{y}=Cₓ/K_{FONT}, where K_{FONT}=1.6. At the next step 2013, the processor 105 sets Cₓ=Cₓ/K_{P}, where K_{P}=2.

At step 2007, if the largest width C_{y} of any sub-modification from A₁ or A₂ is less than the largest height Cₓ of any sub-modification from A₁ or A₂, then the method 2000 proceeds to step 2009. Otherwise the method 2000 proceeds to step 2011. At step 2009, the processor 105 sets Cₓ=C_{y}/K_{FONT}, where K_{FONT}=1.6. At step 2011, the processor 105 sets C_{y}=C_{y}/K_{P}, where K_{P}=2.

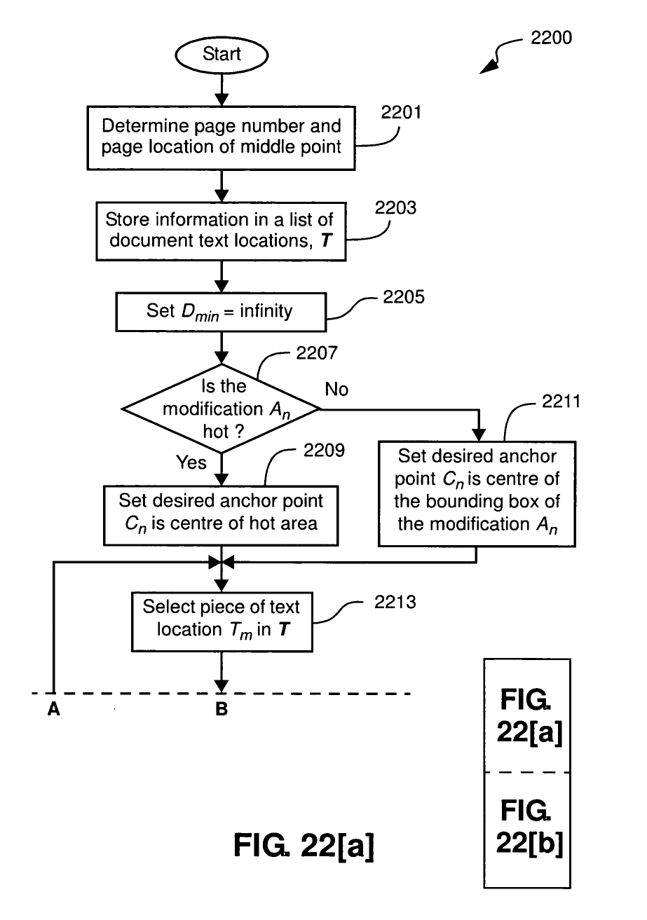

At the next step 2014, the values of Cₓ and C_{y}, are clamped to be between constants C_{MIN} and C_{MAX}, where C_{MIN}=15, and C_{MAX}=200. At the next step 2015, the processor 105 initialises the value of Cost (i.e., the cost of merging the modifications) to infinity. Then at the next step 2017 the processor 105 selects a pair of sub-modifications A′₁ and A′₂ in A₁ and A₂. At the next step 2019, the processor 105 sets the value of Cost=min(Cost, D_{weighted}(A′₁, A′₂, Cₓ, C_{y})), where D_{weighted} represents the shortest distance between scaled bounding boxes of A′₁ and A′₂. A method 2100 of determining the value of D_{weighted} for the sub-modifications A′₁, A′₂ will be described below with reference to FIG. 21. Then at the next step 2021, if there are any more sub-modifications in A₁ and A₂ the method 2000 returns to step 2017. Otherwise, the method 2000 concludes.

The method 2100 of determining the value of D_{weighted} for the sub-modifications A′₁, A′₂ will now be described below with reference to FIG. 21. The method 2100 may be implemented as software resident on the hard disk drive 210 and being controlled in its execution by the processor 105.

The method 2100 begins at the first step 2101, where the processor 105 determines copies of the bounding boxes of the sub-modifications A′₁ and A′₂, and stores the copies in memory 106 or the hard disk drive 110. At the next step 2103, the processor 105 scales the x and y values of the copies of the bounding boxes by 1/Cₓ and 1/C_{y}. Then at the next step 2105, the processor 105 determines the shortest distance D_{weighted} between the two scaled bounding boxes.

Once all of the modifications have been merged as described above, the method 200 concludes at the next step 235, where the processor 105 generates a final list of merged modifications. The final list of merged modifications may be stored in memory 106 of the hard disk drive 110. Each of the merged modifications is associated with one of the modified pages 350 (e.g., 352, 353) and each of the modified pages 350 is associated with a corresponding page (e.g., 301) of the original digital document 300. FIG. 3 shows a set of pages 360, with page 315 of the set of pages 360 showing merged modifications 316, 317, 319 and 321.

As described above, the method 200 may be implemented as one or more software modules of a word processing application. However, once the rendered page images 310 and the scanned page images 320 are generated, the digital document 300 is not required. As a result, the modification lifting and merging may be determined in one or more separate applications or in a different location, such as an MFP (mulit-function peripheral) device.

The merged modifications 316, 317, 319 and 321 may be stored in memory 106 or the hard disk drive 110 in a document-independent file format, external to the digital document 300 itself. Alternatively, the merged modifications 316, 317, 319 and 321 may be stored by an MFP until the modifications 316, 317, 319 and 321 are required. In one implementation, the merged modifications 316, 317, 319 and 321 may be stored as metadata in a document file together with the digital document 300.

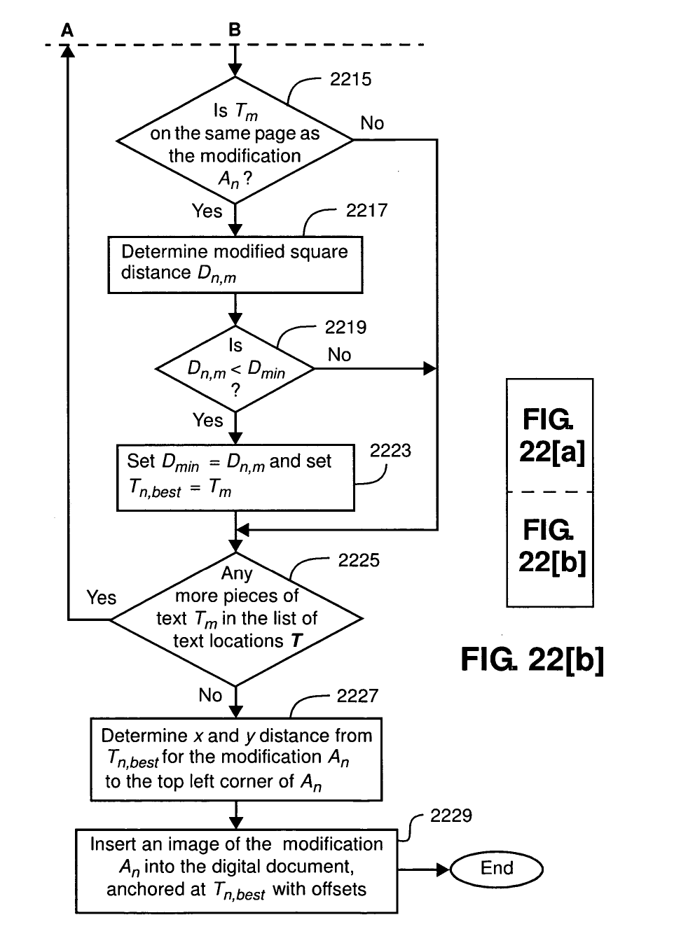

A method 2200 of inserting a modification Aₙ into the digital document 300 at an anchor point T_{n,best}, will now be described with reference to FIG. 22. An anchor point is a location in a digital document with which an image in the document will “flow”. Document flow refers to the repositioning of text and images on a page of a digital document when other text or images have changed in the digital document. For example, if an empty line is inserted at the top of a page full of text, the text flows down by one line, and some text may flow on to a next page. When a user has modified some text (e.g., annotating and amending), the modification preferably flows with the text to which the modification refers. The method 2200 may be implemented as software resident in the hard disk drive 110 and being controlled in its execution by the processor 105.

The method 2200 begins at the first step 2201 where the processor 105 determines information about the digital document 300. This information includes the page number and page location (i.e., relative to the top-left of the page) of a middle point of all words in the document 300. At the next step 2203, the information collected at step 2201 is stored in a list of document text locations, T, configured within memory 106. The text locations of the list, T, may be used to find the best piece of text T_{n,best}, on which to anchor each modification.

The method 2200 continues at the next step 2205, where a variable Dₘᵢₙ is initialised to infinity (i.e., Dₘᵢₙ=∞). Then at the next step 2207, if the processor 105 determines that the modification Aₙ was identified as hot, then the method 2200 proceeds to step 2209. Otherwise, the method 2200 proceeds to step 2211. At step 2209, the processor 105 sets a desired anchor point Cₙ to the centre of the hot area associated with the modification Aₙ (i.e., in x,y coordinates). At step 2211, the processor 105 sets the desired anchor point Cₙ to the centre of the bounding box of the modification Aₙ (i.e., in x, y coordinates). Then at the next step 2213, the processor 105 selects a current piece of text Tₘ from the list of document text locations, T. At the next step 2215, if the processor 105 determines that the selected piece of text Tₘ is on the same modified page (e.g., 352) as the modification Aₙ then the method 2200 proceeds to step 2217. Otherwise, the method 2200 proceeds to step 2225. At step 2217, the processor 105 determines a modified square distance D_{n,m} between Cₙ and Tₘ as follows:
D_{n,m}=(x coordinate of Cₙ−x coordinate of the middle of Tₘ)²+K×(y coordinate of Cₙ−y coordinate of the middle of Tₘ)² (58)
where K is a constant selected to make a vertical distance “longer” than a horizontal distance (e.g., K is selected as ten (10)). Selecting K to make the vertical distance longer than the horizontal distance reduces the likelihood of modifications being anchored to a wrong line of text on a page (e.g., 301) of the document 300. The selection of K in such a manner assumes that lines of text flow horizontally across pages (e.g., 301) of the document 300. Alternatively, K may be set to the inverse when a vertical writing system is in use in the document 300. Modifications are preferably anchored on a nearest line of text, instead of the line above or below the modification, which yields better flow within a single paragraph of text.

The method 2200 continues at the next step 2219, where if the modified square distance D_{n,m} is less than the shortest modified distance Dₘᵢₙ, then the method 2200 proceeds to step 2223. Otherwise, the method 2200 proceeds to step 2225. At the next step 2223, the processor 105 sets the predetermined shortest modified distance Dₘᵢₙ to the modified square distance D_{n,m} determined at step 2217. Also at step 2223, the processor 105 sets an anchor point T_{n,best} to Tₘ. Then at the next step 2225, if there are any more locations of text Tₘ in the list of document text locations, T, then the method 2200 returns to step 2213. Otherwise, the method 2200 proceeds to step 2227, where the processor 105 determines the distances in x (i.e., Δx) and y (i.e., Δy) from the anchor point T_{n,best} for the modification Aₙ to the top-left corner of the modification Aₙ. Then at the next step 2229, the processor 105 inserts an image of the modification into the digital document 300 using an anchor located at the determined anchor point T_{n,best}, with an offset of Δx and Δy, and the method 2200 concludes.

To reduce any confusion caused by visual overlap of the text of the document 300 and the inserted modification Aₙ, the image of the modification Aₙ may be inserted behind the text of the document 300, and the colours in the image may be moved towards white by a whitening factor, W. This whitening factor W may be set to nought point one (0.1). Each colour may be represented by colour values in the red, green, and blue colour channels. If each channel has a value between zero (0) (i.e., black) and C_{MAX} (i.e., maximum intensity) each whiter colour value, c_{white} may be determined from an original colour c_{orig}, using the following formula (59):
c_{white}=C_{MAX}−(1−W)(C_{MAX}−C_{orig}) (59)

C_{MAX} may be set to two hundred and fifty five (255), which is also known as an 8-bit colour depth.

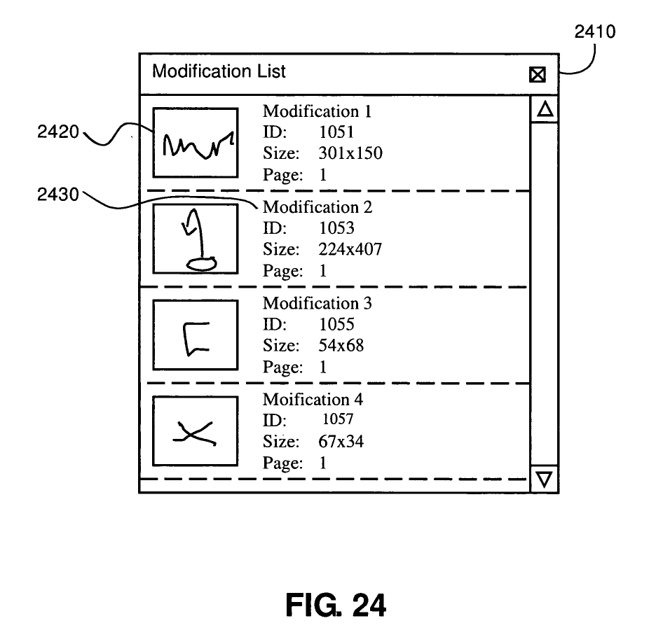

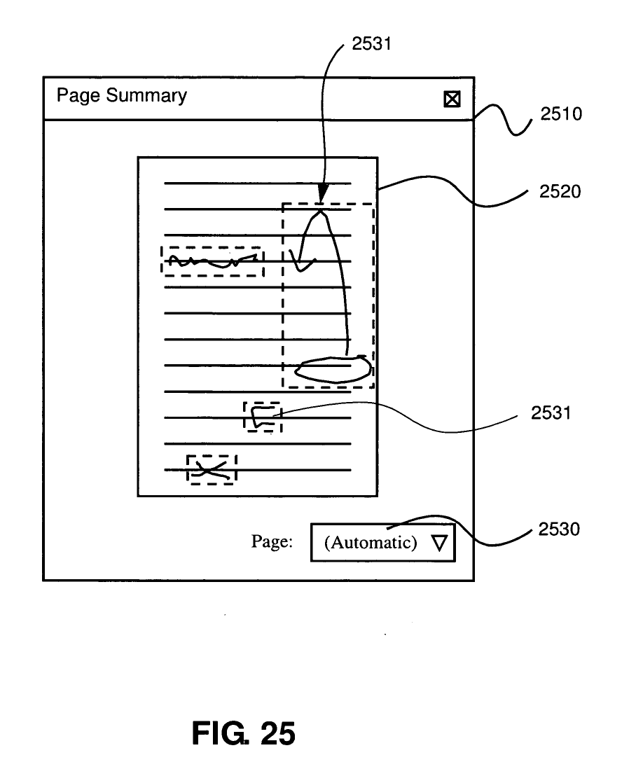

A toolbar 2305 (see FIG. 23), a document window (not shown), a modification listing window 2410 (see FIG. 24), and a page summary view window 2510 (see FIG. 25), for use in implementing the method 200, will now be described. The toolbar 2305, the modification listing window 2410 and the page summary view window 2510, may form a user interface for implementing the method 200. The toolbar 2305, the modification listing window 2410 and the page summary view window 2510, may be implemented as one or more software modules resident on the hard disk drive 110 and being controlled in their execution by the processor 105.

The document window (not shown) may be implemented as a What You See Is What You Get (‘WYSIWYG’) editor showing the digital document 300 with modifications anchored to the locations where the modifications appeared on the printed version of the document 300. In one implementation, the document window may be implemented using Microsoft™ Word™, and the modifications are added as Microsoft™ Word™ shapes. Each shape may be selected and controlled using a document-unique shape identifier, which may be stored in memory 106 with each modification. Alternatively, implementations utilising other word processing software or stand-alone document editing functionality may be used.

The toolbar 2305 is shown in FIG. 23. The toolbar 2305 provides an interface for controlling the modifications in the document 300. The toolbar 2305 comprises a button 2310 for initiating the methods described above. The toolbar 2305 also comprises a button 2320 for controlling visibility of the modification listing window 2410 and a button 2330 for controlling the visibility of the page summary window 2510. The toolbar 2305 also comprises a button 2360 to accept changes to the document 300 which have been made based on a current modification and mark the modification as completed. The toolbar 2305 also comprises a button 2370 to delete the current modifications and not make any changes to the document 300. A button 2380 for clearing completed modifications may also be included in the toolbar 2305. The toolbar 2305 may also comprise an indicator 2390 showing how many modifications remain not completed (i.e., pending), and how many have been completed. The toolbar 2305 also comprises buttons 2340 and 2350 to select previous and next modifications in a list of pending modifications, where the pending modifications are shown in the modifications listing window 2410, as seen in FIG. 24. The modification listing window 2410 displays a list of the pending and completed modifications in the document 300. A modification is pending if the modification has not yet been accepted by the user, as will be described below, and integrated into the document 300. Each modification in the list is shown as a thumbnail image 2420 with other information such as an identifier (id), size, and location 2430.

Once the methods described above have been concluded, the indicator 2390 may be configured to show the number of modifications detected in the document 300.

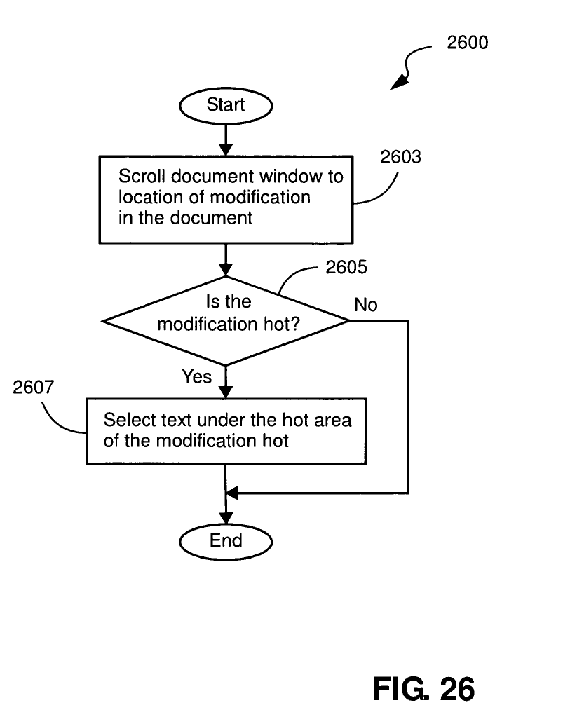

The modification listing window 2410 and the toolbar 2305 may be used to accept or reject detected modifications. For example, a modification may be selected from the list of pending modifications, using the modification list window 2410 and the mouse 103 in a conventional manner. The selected modification is deemed a currently selected modification. In response to such a selection of a modification, the processor 105 may select the text under the hot area of the selected modification if the selected modification is hot. A method 2600 of selecting the text under the hot area of the selected modification, will now be described below with reference to FIG. 26. The method may be implemented as software resident on the hard disk drive 110 and being controlled in its execution by the processor 105.

The method 2600 begins at the first step 2603, where the processor 105 scrolls the document window (not shown) to the location of the selected modification in the document 300, and a cursor is placed where the modification is anchored in the document 300. Then at the next step 2605, if the modification was determined to be hot, as at step 215 of the method 200, then the method 2600 proceeds to step 2607. Otherwise, the method 2600 concludes. At step 2607, the processor 105 selects the text under the hot area of the selected modification. The hot area stored in memory 106 and associated with the selected modification may not correspond correctly with the document 300 as the location of the modification may have moved. In this instance, the location of the hot area for the selected modification may be determined again by the processor 105 based on the current anchor point for the modification. The method 2600 concludes following step 2607.

If a user decides to make no changes based on a selected modification, for example, if the selected modification is an accidental pen mark on a hard copy of page 301 of the document 300 and does not represent a real modification (e.g., annotation or amendment), then the user may delete the selected modification from the list of pending modifications using the delete button 2370. In this instance, the modification may be removed from the document 300 as well as from the list of pending modifications. If the user chooses to make changes to the document selected in response to a selected modification then the user may type in the changes using the keyboard 102, for example. Once the changes have been made to the document, then the user may accept the changes to the document by clicking on the accept button 2360 of the toolbar 2305, using the mouse 103. If a user chooses to accept a selected modification, then the image representing the selected modification may be removed from document 300 in accordance with the method 2200. In this instance, the selected modification is moved to a list of completed modifications and the modification is then shown in the modification list window 2410 in a grey colour. If the user double-clicks on a completed modification (i.e., a grey coloured modification), using the mouse in a conventional manner, the processor 105 may be configured to place the selected completed modification back into the document 300 and mark the modification as pending once more.

If the processor 105 determines that the user has selected the clear modification list button 2380 of the toolbar 2305, the processor 105 clears all of the completed modifications from the list of completed modifications.

FIG. 25 shows the page summary view window 2510, with the image of a currently visible page 2520 as the page appears in the set of rendered page images 310, with modifications (e.g., 2531) added to the page 2520 placed on top. Each modification 2531 may be rendered with a faint box surrounding the modification to indicate the location of the modification 2531. Pending modifications may be given a different coloured box to completed modifications. A currently selected modification may be highlighted with a brightly coloured box. If the user wishes to view a page other than the currently selected page in the document window, the user may choose the page to be displayed from a list 2530. The user may also click on a modification list window 2410 to have the page summary window 2510 display the page of the document 300 containing the selected modification. In this instance, the newly selected modification becomes the currently selected modification.

The methods described above have been described assuming that a plurality of pages (e.g., 301, 302 and 303) exist in the digital document 300. The methods described above are equally applicable to digital documents containing only a single page.

The aforementioned preferred method(s) comprise a particular control flow. There are many other variants of the preferred method(s) which use different control flows without departing the spirit or scope of the invention. Furthermore one or more of the steps of the preferred method(s) may be performed in parallel rather sequentially.

The foregoing describes only some embodiments of the present invention, and modifications and/or changes can be made thereto without departing from the scope and spirit of the invention, the embodiments being illustrative and not restrictive. For example, in one implementation, when generating the rendered page images 310 the printer 115 may be configured to store images of document pages as the images are printed, and to generate a unique identifier to be stored with the document. When the images of the document pages are required, the processor 105 may request the images from the printer 115 using the unique identifier.

In still another implementation, either the rendered page images 310 or the scanned page images 320 may be collected in a single disk file using a format which is able to hold multiple page images, for example, the Portable Document Format (PDF). The single disk file may be generated automatically by an MFP multifunction peripheral device from pages in the document feeder of the MFP device.

In still another implementation, specialised software inside an MFP device may be used to generate the scanned images 320 from the printed version of the document 300 in the document feeder of the MFP device, and then process the scanned images in accordance with the methods described above.

In still another implementation, modifications may be collected from a plurality of authors for the scanned page images 320 by scanning differently modified printed copies of the document 300 and associating multiple scanned page images with the each rendered page image (e.g, 311).

1. A method of modifying a digital document, said method comprising the steps of:
converting said digital document into one or more first digital images;
generating one or more second digital images of a modified version of a hard copy of said digital document;
comparing the first one or more digital images with the second one or more color digital images to determine the modifications made to the hard copy of the digital document; and
modifying the digital document based on the determined modifications.

2. The method according to claim 1, further comprising the step of aligning the first one or more digital images with the second one or more digital images to determine one or more registered digital images.

3. The method according to claim 2, wherein the first digital images and the second digital images are color digital images, further comprising the step of aligning the colors of the first one or more color digital images with the colors of the one or more registered digital images.

4. The method according to claim 3, further comprising the step of comparing the color aligned registered digital images with the first one or more color digital images to determine the modifications made to the hard copy of the digital document.

5. The method according to claim 4, further comprising the step of merging the determined modifications made to the hard copy of the digital document to determine one or more modified digital images.

6. The method according to claim 5, wherein the determined modifications are merged based on a predetermined threshold cost of merging two or more modifications.

7. The method according to claim 5, further comprising the step of removing any insignificant modifications from the one or more modified digital images.

8. The method according to claim 1, further comprising the step of inserting the determined modifications into the digital document.

9. The method according to claim 8, wherein one or more inserted modifications are anchored to associated text of said digital document.

10. The method according to claim 1, wherein said digital document comprises at least three colors.

11. The method according to claim 1, wherein the second one or more digital images are generated using a scanning process or a copying process.

12. An apparatus for modifying a digital document, said apparatus comprising:
conversion means for converting said digital document into one or more first digital images;
digital image generating means for generating one or more second digital images of a modified version of a hard copy of said digital document;
comparison means for comparing the first one or more digital images with the second one or more digital images to determine the modifications made to the hard copy of the digital document; and
digital document modifying means for modifying the digital document based on the determined modifications.

13. A computer program for modifying a digital document, said program comprising:
code for converting said digital document into one or more first digital images;
code for generating one or more second digital images of a modified version of the hard copy of said digital document;
code for comparing the first one or more color digital images with the second one or more color digital images to determine the modifications made to a hard copy of the digital document; and
code for modifying the digital document based on the determined modifications.

14. A computer program product having a computer readable medium having a computer program recorded therein for modifying a digital document, said computer program product comprising:
computer program code means for converting said digital document into one or more first digital images;
computer program code means for generating one or more second digital images of a modified version of a hard copy of said digital document;
computer program code means for comparing the first one or more digital images with the second one or more digital images to determine the modifications made to the hard copy of the digital document; and
computer program code means for modifying the digital document based on the determined modifications.

15. A method of determining the difference between at least a first and second digital image, said method comprising the steps of:
aligning the first digital image with the second digital image to determine one or more registered digital images;
aligning the colors of the first digital image with the colors of the one or more registered digital images to determine one or more color aligned digital images; and
comparing the color aligned registered digital images with the first digital image to determine one or more differences between the first and second digital images.

16. The method according to claim 15, further comprising the step of determining one or more parameters based on a predetermined color model.

17. The method according to claim 16, wherein said one or more parameters minimise a sum or errors between predicted and actual colors of the first and second digital images.

18. The method according to claim 16, wherein said one or more parameters map the colors in the second digital image to the colors in the first digital image.

19. The method according to claim 15, wherein the comparison is based on predetermined threshold.

20. The method according to claim 15, further comprising the step of modifying the second digital image based on the determined differences.

21. The method according to claim 15, wherein said digital images comprise at least three colors.

22. An apparatus for determining the difference between at least a first and second digital image, said apparatus comprising:
digital alignment means for aligning the first digital image with the second digital image to determine one or more registered digital images;
color alignment means for aligning the colors of the first digital image with the colors of the one or more registered digital images to determine one or more color aligned digital images; and
comparison means for comparing the color aligned registered digital images with the first digital image to determine one or more differences between the first and second digital images.

23. A computer program for determining the difference between at least a first and second digital image, said program comprising:
code for aligning the first digital image with the second digital image to determine one or more registered digital images;
code for aligning the colors of the first digital image with the colors of the one or more registered digital images to determine one or more color aligned digital images; and
code for comparing the color aligned registered digital images with the first digital image to determine one or more differences between the first and second digital images.
